(19) United States
(12) Patent Application Publication
(10) Pub. No.: US 2025/0307958 A1
(43) Pub. Date: Oct. 2, 2025

(54) RESERVOIR ECOLOGICAL OPERATION METHOD INTEGRATING ECOLOGICAL FLOW PROCESS AND WATER TEMPERATURE PROCESS REQUIREMENTS OF FISH SPECIES

(71) Applicant: NANJING HYDRAULIC RESEARCH INSTITUTE, Jiangsu (CN)

(72) Inventors: Qiuwen Chen, Jiangsu (CN); Jianyun Zhang, Jiangsu (CN); Yuqing Lin, Jiangsu (CN); Tiesheng Guan, Jiangsu (CN)

(73) Assignee: NANJING HYDRAULIC RESEARCH INSTITUTE, Jiangsu (CN)

(21) Appl. No.: 19/060,760

(22) Filed: Feb. 23, 2025

(30) Foreign Application Priority Data
Apr. 2, 2024 (CN) 202410389706.5

(51) Int. Cl. A01K 61/95; A01K 61/10; G06Q 50/02; G06Q 50/06

(52) U.S. Cl. CPC G06Q 50/06; G06Q 50/02

(57) ABSTRACT

Disclosed is a reservoir ecological operation method integrating ecological flow process and water temperature process requirements of fish species, including: establishing a habitat model for a target fish species and deducing an ecological flow process of a lift history of the target fish species; calculating a critical spawning water temperature threshold and a critical gonadal development accumulated temperature threshold; establishing a multi-objective reservoir operation model to obtain flow process and water level after optimized reservoir operation; establishing a multi-objective reservoir ecological operation model integrating both the ecological flow process and the water temperature process, and calculating reservoir outflow water temperatures before and after the optimized reservoir operation; and calculating an improvement difference between the critical water temperature threshold and the accumulated temperature threshold of the target fish species on arrival dates after the reservoir ecological operation and those before the optimized reservoir operation.

### CROSS-REFERENCE TO RELATED APPLICATION

This application claims the priority benefit of China application serial no. 202410389706.5, filed on Apr. 2, 2024. The entirety of the above-mentioned patent application is hereby incorporated by reference herein and made a part of this specification.

### TECHNICAL FIELD

The present disclosure relates to the field of river basin water resource management, and particularly relates to a reservoir ecological operation method integrating ecological flow process and water temperature process requirements of fish species.

### BACKGROUND

A reservoir can not only meet human needs, but also meet ecological flow or water temperature requirements for fish in a river through ecological operation, which is a fundamental task in reservoir operation, and is also a fundamental need for the protection of river ecosystems. Existing ecological operation methods for fish conservation mostly focus on ecological flow or water temperature requirements of fish species. For reservoir ecological operation considering ecological flow needs of fish species, hydrological methods, such as Tennant method, RVA method, monthly (annual) assurance rate setting method, and three-segment method (Texas method), are often adopted to determine ecological flow of a river. An ecological flow value of the river is used as ecological flow for discharge of the reservoir, upon which operation parameters of the reservoir are adjusted to maximize power generation, water supply, navigation satisfaction, or flood control benefits. The operation methods can satisfy basic ecological water needs of the river to some extent, but it is difficult for the methods to better meet ecological flow needs of a target fish species in different life history stages in the river. The fish species has different flow requirements in different life history stages. In a spawning stage, a continuous increase in flow is required. In a gonadal development stage, flow stimulation is conducive to gonadal development of the fish species. In addition to flow, water temperature of the river also affects a spawning intensity of the fish species. The water temperature needs to reach a critical temperature to trigger spawning of the fish species. Moreover, fish spawning is not only associated with a critical water temperature but also to an accumulated temperature, which reflects thermal needs of the fish species for river temperature in the gonadal development stage. Generally, completion of the gonadal development stage is a prerequisite for the fish species to enter the spawning stage. Therefore, existing reservoir ecological operation methods, which only consider meeting the flow or water temperature needs of the fish species downstream, consider neither different needs of the fish species in different life history stages, nor matching of critical water temperature threshold and accumulated temperature threshold that affect fish spawning, making it difficult to effectively protect the fish species in the river ecosystems. On the basis of ensuring human life and property safety, and meeting economic benefits, such as power generation, flood control, water supply, and navigation, it is necessary to balance ecological flow and water temperature needs of the fish species in the river ecosystems, and achieve maximum protection for the river ecosystems, which are the problems unsolved by the existing reservoir ecological operation methods for fish conservation.

### SUMMARY

Objectives of the present disclosure: the present disclosure aims to provide a reservoir ecological operation method integrating ecological flow process and water temperature process requirements of fish species, which guarantees the economic benefits of power generation, water supply, and navigation for the human being, and considers both needs for flow process and water temperature of the target fish species in different stages of lift history, especially needs of fish in spawning stage and gonadal development stage, thereby achieving the maximum protection of fish in a river more effectively.

Technical solution: in order to achieve the above objectives, the present disclosure discloses a reservoir ecological operation method integrating ecological flow process and water temperature process requirements of fish species, which specifically includes the following sub-steps:
(1) establishing a habitat model for a target fish species and deducing an ecological flow process of a lift history of the target fish species;
(2) calculating a critical spawning water temperature threshold and a critical gonadal development accumulated temperature threshold of the target fish species based on historical river water temperature data before dam construction, and calculating a critical spawning water temperature threshold and a critical gonadal development accumulated temperature threshold of the target fish species under an influence of current reservoir operation regulations based on river water temperature data after the dam construction;
(3) establishing a multi-objective reservoir operation model orienting to needs of the ecological flow process throughout a life history of the target fish species to obtain flow process and water level after the optimized reservoir operation;
(4) coupling a water temperature model based on the multi-objective reservoir operation model orienting to needs of the ecological flow process to establish a multi-objective reservoir ecological operation model integrating both the ecological flow process and the water temperature process, and calculating reservoir outflow water temperatures before and after the optimized reservoir operation; and
(5) calculating an improvement difference between the critical water temperature threshold and the accumulated temperature threshold of the target fish species on arrival dates after reservoir ecological operation and those before the optimized reservoir operation, as well as a difference between the critical water temperature threshold and the accumulated temperature threshold of the target fish species after the reservoir ecological operation and those in an ideal state of the river before the dam construction.

Specifically, the step (1) specifically includes the following sub-steps:
(1.1) determining the target fish species based on an analytic hierarchy process;
(1.2) establishing a water environment model to simulate hydrodynamic changes and water quality factor concentration changes in a main habitat river section of the target fish species;
(1.3) investigating frequencies, distribution locations, area sizes, activities, and migration patterns of spawning ground, overwintering ground, and juvenile fish rearing ground of the target fish species, and recording flow rate, water temperature, water level, flow velocity, and dissolved oxygen value of each of the corresponding grounds as validation data for a fish habitat model;
(1.4) conducting behavioral experiments on the target fish species to establish a response relationship between behavior of the target fish species and flow rate, flow velocity, water temperature, and dissolved oxygen, obtaining a response curve between occurrence frequency of the target fish species and hydraulic characteristics, as well as a response curve between occurrence frequency of the target fish species and water quality factors;
(1.5) extracting flow rate and flow velocity results from the hydrodynamic changes in the main habitat river section of the target fish species, extracting water temperature and dissolved oxygen results from the water quality factor concentration changes in the main habitat river section, establishing a membership function between the occurrence frequency of the target fish species and hydraulic characteristics, and water quality characteristics based on a fuzzy membership in combination with the flow rate and flow velocity results, the water temperature and dissolved oxygen results, the response curve between occurrence frequency of the target fish species and hydraulic characteristics, and the response curve between occurrence frequency of the target fish species and water quality factors, and establishing a target fish species habitat model; and
(1.6) taking the flow rate and flow velocity in the hydraulic characteristics, as well as the water temperature and dissolved oxygen in the water quality factors as inputs, and the occurrence frequency of the target fish species as outputs; setting the occurrence frequency of the target fish species as an objective function for optimization using a genetic algorithm, set population size, number of iterations, crossover probability, and mutation probability for the genetic algorithm, optimizing the membership function and fuzzy rules of the fish habitat model using the genetic algorithm, and validating whether the occurrence frequency of the target fish species in the target fish species habitat model is consistent with occurrence frequency of the target fish species in a field survey; when the occurrence frequency of the target fish species in the target fish species habitat model is inconsistent with that in the field survey, and an error between the model and the field survey is more than 10%, the population size, number of iterations, crossover probability, and mutation probability for the genetic algorithm are adjusted, and the target fish species habitat model is optimized again until the error between the model and the field survey is less than 10%, such that a target fish species habitat model corresponding to an optimal membership and fuzzy rules is obtained;
(1.7) taking suitability index and continuity index as evaluation indicators to establish a dynamic response relationship among habitat flow rate−suitability index, and flow rate−continuity curve for the optimized target fish species habitat model; and
(1.8) taking a flow rate corresponding to an optimal suitability index and connectivity index to calculate the ecological flow process throughout the life history of the target fish species based on the dynamic response relationship among habitat flow rate−suitability index, and flow rate−continuity curve, and dividing the ecological flow process into a minimum ecological flow process and a suitable ecological flow process; where an ecological flow process corresponding to a habitat restoration target of 60% is taken as the minimum ecological flow process, indicating that 60% of a target fish species habitat throughout the life history is recovered, and an ecological flow process corresponding to a habitat restoration target of 100% is taken as the suitable ecological flow process, indicating that 100% of the target fish species habitat throughout the life history is restored.

Preferably, the step (1.2) specifically includes the following sub-steps:
(1.2.1) collecting DEM data, topographic data, average daily flow rate, average daily water level and water temperature data, and analyzing and determining a characteristic hydrological year of a study basin in combination with supplementary monitoring; establishing an unsteady one-dimensional hydrodynamic model for the entire study basin under the reservoir operation based on a reservoir operating mode, and simulating hydraulic characteristics of a downstream river course under the influence of reservoir operation in the characteristic hydrological year; where the hydraulic characteristics include flow rate, water level, and flow velocity, and the main habitat river section of the target fish species is then determined;
(1.2.2) establishing a two-dimensional hydrodynamic model for the main habitat river section of the target fish species, taking output results of the flow rate and water level from the unsteady one-dimensional hydrodynamic model as boundary conditions for the two-dimensional hydrodynamic model, coupling the unsteady one-dimensional hydrodynamic model to the two-dimensional hydrodynamic model to form a coupled hydrodynamic model, and simulating hydrodynamic changes in the main habitat river section of the target fish species; and
(1.2.3) establishing a one-dimensional water quality model for the entire study basin under the reservoir operation based on the reservoir operating mode, establishing a two-dimensional water quality model for the main habitat river section of the target fish species, taking output results of the dissolved oxygen and water temperature from the one-dimensional water quality model as boundary conditions for the two-dimensional water quality model, coupling the one-dimensional water quality model to the two-dimensional water quality model to form a coupled hydrodynamic model, and simulating concentration changes in water quality factors in the main habitat river section of the target fish species.

Further, the step (2) specifically includes the following sub-steps:
(2.1) calculating an average daily river water temperature over many years based on the historical river water temperature data before dam construction; and calculating an average daily river water temperature downstream of the dam based on the current river water temperature data according to the current operation regulation;
(2.2) calculating critical water temperature threshold and accumulated temperature threshold of the target fish species based on a historical daily river water temperature average; and
(2.3) calculating critical water temperature threshold and accumulated temperature threshold of the target fish species under the influence of current reservoir operation regulations based on an average daily water temperature downstream according to the current operation regulation.

Further, the step (3) specifically includes the following sub-steps:
(3.1) taking maximum power generation, highest satisfaction rate of ecological flow of the target fish species, highest water supply satisfaction rate, and longest suitable navigation period as objective functions of the multi-objective reservoir operation model;
a) the maximum power generation

$${f}_{1} = max {\sum }_{t = 1}^{T} {\sum }_{i = 1}^{2} {N}_{i , t} Δ t \qquad ( 7 )$$

$${N}_{i , t} = {K}_{i} \cdot {Q}_{i , t}^{g} \cdot Δ {H}_{i , t} \qquad ( 8 )$$

in the formulae, f₁ is an objective function for power generation; T is a total calculation period length; N_{i,t} is a power output of an i^{th} reservoir of t time steps, in kW; Δt is a unit calculation time step; Kᵢ is a hydraulic power generation coefficient of the i^{th} reservoir;

$${Q}_{i , t}^{g}$$

is a power generation flow of an i^{th} hydropower station at a time period t, in m³/s; and ΔH_{i,t} is an average water level head of the i^{th} reservoir of the t time steps, in m;
b) the highest satisfaction rate of ecological flow
when an outflow from the reservoir is lower than the minimum ecological flow process as stated in the step (1) throughout the life history of the target fish species, the satisfaction rate of ecological flow is 0; when the outflow from the reservoir falls within the minimum ecological flow process and the suitable ecological flow process as stated in the step (1) throughout the life history of the target fish species, the satisfaction rate of ecological flow increases with an increase in the flow rate; and when the outflow from the reservoir is greater than the suitable ecological flow process as stated in the step (1) throughout the life history of the target fish species, the satisfaction rate of ecological flow is 1;
an objective function for the satisfaction rate of ecological flow of the target fish species is as follows:

$${f}_{2} = max \frac{1}{T} {\sum }_{t = 1}^{T} {\sum }_{i = 1}^{2} {R}_{i , t} \qquad ( 9 )$$

$${R}_{i , t} = \{ \begin{matrix}0 & {Q}_{i , t}^{out} < {Q}_{t , min} \\ \frac{{Q}_{i , t}^{out} - {Q}_{t , min}}{{Q}_{t , pro} - {Q}_{t , min}} & {Q}_{t , min} < {Q}_{i , t}^{out} < {Q}_{t , pro} \\ 1 & {Q}_{t , pro} < {Q}_{i , t}^{out}\end{matrix} \qquad ( 10 )$$

where f₂ is an objective function for the satisfaction rate of ecological flow of the target fish species; Q_{t,min} and Q_{t,pro} are minimum ecological flow need and suitable ecological flow need of the target fish species at a t^{th} time period, respectively, in m³/s;

$${Q}_{i , t}^{out}$$

is an outflow of the i^{th} reservoir of t time steps, in m³/s; and T is a total calculation period length;
c) the highest water supply satisfaction rate

$${f}_{3} = max \frac{1}{T} {\sum }_{i = 1}^{T} \frac{{Q}_{sw , t}}{{Q}_{sw , t}^{demand}} \qquad ( 11 )$$

in the formulae, f₃ is an objective function for the water supply satisfaction rate;

$${Q}_{sw , t}^{demand}$$

is a total water demand of t time steps, in m³/s, which is extracted from a water resources bulletin; Q_{sw,t} is a water supply flow of the t time steps, in m³/s; and T is a total calculation period length;
d) the longest suitable navigation period

$${f}_{4} = max \{ \frac{{T}_{nav}}{T} \times 100 \% \} \qquad ( 12 )$$

$${T}_{nav} = \{ t \vert {q}_{i , min}^{nav} \leq {Q}_{i , t}^{out} \leq {q}_{i , max}^{nav} , t ∈ T \} \qquad ( 13 )$$

in the formulae, f₄ is an objective function for navigation; T is a total calculation period length; Tₙₐᵥ is a suitable navigation period;

$${q}_{i , min}^{n a v} and {q}_{i , max}^{n a v}$$

are upper and lower bounds of a suitable navigation flow range downstream of the i^{th} reservoir, in m³/s; and

$${Q}_{i , t}^{out}$$

is an outflow of the i^{th} reservoir of the t time steps, in m³/s;
(3.2) determining constraint conditions of the multi-objective reservoir operation model, and the constraint conditions include: reservoir water level constraint, reservoir capacity constraint, power output constraint, outflow constraint, and variable non-negative constraint;
a) the reservoir water level constraint

$${H}_{i , t}^{min} \leq {H}_{i , t} \leq {H}_{i , t}^{max} \qquad ( 14 )$$

in the formula,

$${H}_{i , t}^{min}$$

is a minimum water level of the i^{th} reservoir, equal to a dead storage level, in m; H_{i,t} is a water level of the i^{th} reservoir of the t time steps, in m;

$${H}_{i , t}^{max}$$

is a maximum water level of the i^{th} reservoir of the t time steps, which is a flood limit water level during a flood season and a normal storage level during a non-flood season, in m;
b) the reservoir capacity constraint

$${V}_{i , t + 1} - {V}_{i , t} = ( {Q}_{i , t}^{in} + {q}_{t} - {Q}_{i , t}^{out} ) Δ t \qquad ( 15 )$$

$${Q}_{i , t}^{out} = {Q}_{i , t}^{g} + {Q}_{i , t}^{spi} \qquad ( 16 )$$

in the formulae, V_{i,t+1} and V_{i,t} are final and initial reservoir capacities of the i^{th} reservoir of the t time steps, in m³;

$${Q}_{i , t}^{in}$$

is an inflow into the i^{th} reservoir, in m³/s; qₜ is an inter-reservoir flow between cascade reservoirs, in m³/s;

$${Q}_{i , t}^{out}$$

is an outflow of the i^{th} reservoir of the t time steps, in m³/s;

$${Q}_{i , t}^{g}$$

is a hydropower diversion flow of the i^{th} reservoir, in m³/s; and

$${Q}_{i , t}^{spi}$$

is spilled water of the i^{th} reservoir, in m³/s;
c) power output constraint

$${N}_{i}^{min} \leq {N}_{i , t} \leq {N}_{i}^{max} \qquad ( 17 )$$

in the formula,

$${N}_{i}^{min} and {N}_{i}^{max}$$

are minimum and maximum power outputs of the i^{th} reservoir, respectively, in kW; and N_{i,t} is a power output of the i^{th} reservoir of the t time steps, in kW;
d) the outflow constraint

$${Q}_{i}^{min} \leq {Q}_{i , t}^{out} \leq {Q}_{i}^{max} \qquad ( 18 )$$

in the formula,

$${Q}_{i}^{min} and {Q}_{i}^{max}$$

minimum and maximum allowable outflows from the i^{th} reservoir, respectively, in m³/s; and

$${Q}_{i , t}^{out}$$

is an outflow from the i^{th} reservoir of the t time steps, in m³/s;
e) the variable non-negative constraint

$${V}_{i , t} , {N}_{i , t} , {Q}_{i , t}^{out} \geq 0 \qquad ( 19 )$$

V is a reservoir capacity of the i^{th} reservoir of the t time steps, in m³; N_{i,t} is a power output of the i^{th} reservoir of the t time steps, in kW; and

$${Q}_{i , t}^{out}$$

is an outflow from the i^{th} reservoir of the t time steps, in m³/s; and
(3.3) optimizing and solving the multi-objective reservoir operation model orienting to needs of the ecological flow process based on a third-generation non-dominated genetic algorithm (NSGA-III); and iteration stops when an objective function value does not update any longer with an increase in the number of iterations, such that an optimized flow process and water level for the reservoir are obtained.

Preferably, the step (4) specifically includes the following sub-steps:
(4.1) collecting vertical water temperature measurement data upstream of the reservoir and time series water temperature measurement data downstream of the reservoir;
(4.2) establishing the water temperature model, setting initial values for longitudinal eddy viscosity, longitudinal eddy diffusion rate, Manning's coefficient and wind shelter coefficient, surface solar radiation absorption coefficient, and pure water extinction coefficient of the water temperature model, and inputting reservoir inflow, outflow, water level, and meteorological data corresponding to the measured water temperature data at a same time into the water temperature model; where the meteorological data include air temperature, wind speed, wind direction, dew point temperature, and shortwave radiation;
(4.3) setting an outlet of the water temperature model to 2 outlet elevations of the current operation regulation, and calculating a reservoir outflow water temperature;
(4.4) comparing the calculated reservoir outflow water temperature with measured water temperature data; when an error between the calculated reservoir outflow water temperature and the measured outflow water temperature is great than 10%, the initial values for longitudinal eddy viscosity, longitudinal eddy diffusion rate, Manning's coefficient and wind shelter coefficient, surface solar radiation absorption coefficient, and pure water extinction coefficient of the water temperature model are adjusted, until a calculated error between the calculated reservoir outflow water temperature and the measured outflow water temperature is less than 10% to obtain calibrated and verified longitudinal eddy viscosity, longitudinal eddy diffusion rate, Manning's coefficient and wind shelter coefficient, surface solar radiation absorption coefficient, and pure water extinction coefficient;
(4.5) inputting the calibrated and verified longitudinal eddy viscosity, longitudinal eddy diffusion rate, Manning's coefficient and wind shelter coefficient, surface solar radiation absorption coefficient, and pure water extinction coefficient, and the water level and the outflow from the reservoir (that is, the optimized flow process and water level for the reservoir) calculated from the optimized multi-objective reservoir operation model in the step (3.3), as well as the corresponding meteorological data (including air temperature, wind speed, wind direction, dew point temperature, and shortwave radiation) into the water temperature model, setting an outlet elevation of the current operation regulation, and calculating reservoir outflow water temperatures before and after the optimized reservoir operation;
(4.6) setting up 8 outlets in the outlet setup for the water temperature model, where the 8 outlets include 2 outlets based on the current operation regulation, 4 outlets with elevated outlet elevation, and 2 outlets with lowered outlet elevation; the 4 elevated outlets are set as candidate outlets from March to June; the 2 lowered outlets are set as candidate outlets from October to the following January; and the 2 outlets based on the current operation regulation are used in remaining months;
(4.7) in the outlet setup for the water temperature model, using a historical daily water temperature average before the dam construction as a target; for the candidate outlets, outlet elevations for the 4 candidate outlets from March to June are optimized using the genetic algorithm, and for the 2 candidate outlets from October to the following January are optimized using the genetic algorithm, to obtain optimized outlet elevations from March to June, and from October to the following January, and outlet elevations for the remaining months are set according to the current operation regulation; and
(4.8) inputting the water level and the outflow from the reservoir (that is, the optimized flow process and water level for the reservoir) for the reservoir calculated from the optimized multi-objective reservoir operation model orienting to needs of the ecological flow process in the step (3.3), as well as the corresponding meteorological data (including air temperature, wind speed, wind direction, dew point temperature, and shortwave radiation) into the water temperature model, and setting as the optimized outlet elevations to calculate a reservoir outflow water temperature after the optimized reservoir operation.

Further, a governing equation for the water temperature model in the step (4) is as follows:

$$\frac{\partial UB}{\partial t} + \frac{\partial UUB}{\partial x} + \frac{\partial WUB}{\partial z} = gB sin α + g cos αβ \frac{\partial η}{\partial x} - \frac{g cos αβ}{ρ} {\int }_{η}^{z} \frac{\partial ρ}{\partial x} dz + \frac{1}{ρ} \frac{\partial B {τ}_{xx}}{\partial x} + \frac{1}{ρ} \frac{\partial B {τ}_{xz}}{\partial z} + {qBU}_{x} \qquad ( 20 )$$

$$0 = g cos α - \frac{1}{ρ} \frac{\partial P}{\partial z} \qquad ( 21 )$$

$${B}_{η} \frac{\partial η}{\partial } = \frac{\partial }{\partial x} {\int }_{η}^{h} UBdz - {\int }_{η}^{h} qBdz \qquad ( 22 )$$

$$\frac{\partial UB}{\partial x} + \frac{\partial WB}{\partial z} = qB \qquad ( 23 )$$

$$ρ = f ( {T}_{w} , {ϕ}_{TDS ,} {ϕ}_{ss} ) \qquad ( 24 )$$

$$\frac{\partial B ϕ}{\partial t} + \frac{\partial UB ϕ}{\partial x} + \frac{\partial WB ϕ}{\partial z} - \frac{\partial ( {BD}_{x} \frac{\partial ϕ}{\partial x} )}{\partial x} - \frac{\partial ( {BD}_{z} \frac{\partial ϕ}{\partial z} )}{\partial z} = {q}_{ϕ} B + {S}_{ϕ} B \qquad ( 25 )$$

where U is a horizontal flow velocity, B is a river course width, g is an acceleration of gravity, ∂x, ∂y and ∂z denote partial derivatives with respect to x, y, and z directions, respectively, W is a vertical flow velocity, a is a river course angle, η is a water surface elevation, ρ is a density, q is a flow rate per unit width, P is a pressure, ϕ is concentration or temperature, T_{w} is a water temperature, ϕ_{TDS} is total dissolved solid concentration or salinity, ϕₛₛ is an inorganic suspended solid concentration, and h is a depth.

Further, the step (5) specifically includes the following sub-steps:
(5.1) identifying the reservoir outflow water temperature after the optimized reservoir operation as daily average river water temperature after the reservoir ecological operation, and calculating critical water temperature threshold and accumulated temperature threshold of the target fish species after the reservoir ecological operation;
(5.2) subtracting an arrival date of the critical water temperature threshold under the current operation regulation (that is, conventional operation) from an arrival date of the critical water temperature threshold of the target fish species after the reservoir ecological operation to obtain an improvement difference of the critical water temperature threshold of the target fish species after the reservoir ecological operation; and subtracting the critical water temperature threshold of the target fish species before the dam construction from the critical water temperature threshold of the target fish species after the reservoir ecological operation to obtain a difference between the critical water temperature threshold of the target fish species after the reservoir ecological operation and that in an ideal state of the river before the dam construction; and
(5.3) subtracting the accumulated temperature threshold of the target fish species under the current operation regulation (that is, conventional operation) from the accumulated temperature threshold of the target fish species after the reservoir ecological operation to obtain an improvement difference of the accumulated temperature threshold of the target fish species after the reservoir ecological operation; and subtracting the accumulated temperature threshold of the target fish species before the dam construction from the accumulated temperature threshold of the target fish species after the reservoir ecological operation to obtain a difference between the accumulated temperature threshold of the target fish species after the reservoir ecological operation and that in an ideal state of the river before the dam construction.

Further, in the steps (2.2), (2.3) and (5.1), a river water temperature at which the average daily river water temperature reaches a level stably for the first time is selected as the critical water temperature threshold, where the level can trigger spawning behavior of the target fish species; and “reach stably for the first time” means that the water temperature has been continuously higher than the water temperature value for the next 3 consecutive days.

Further, in the steps (2.2), (2.3) and (5.1), the accumulated temperature is calculated and obtained by summing parts with temperature higher than a biological individual development temperature T₀ from a developmental stage to a mature stage (in days); in the process of calculating the accumulated temperature, assuming a plurality of the biological individual development temperatures as T₀ to minimize a difference among the accumulated temperatures in each survey year; and a variation range of an individual developmental temperature

$${T}_{0}^{fish}$$

of the target fish species is often determined based on a temperature at the beginning of the developmental stage of the target fish species, usually assumed to be in a range of 0-15° C.;
a calculation formula for the accumulated temperature threshold K of the target fish species is expressed as:
K=min (K_{mf}), K_{mf} is the K_{mα} obtained when

$${T}_{0 m} = {T}_{0}^{fish}$$

in a statistical year,

$${T}_{0}^{fish} = {T}_{0 f} ,$$

T_{0f} is an assumed T_{mα} when SDₘ is a minimum value (1)

$${SD}_{f} = min ( {SD}_{1} , {SD}_{2} ... {SD}_{m} ) \qquad ( 2 )$$

$${SD}_{m} = \sqrt{\frac{{\sum }_{α = 1}^{L} {( {K}_{m α} - \overline{K} )}^{2}}{L}} \qquad ( 3 )$$

$$\overline{{K}_{m}} = ( \frac{{\sum }_{α = 1}^{L} {K}_{m α}}{L} ) \qquad ( 4 )$$

$${K}_{m α} = {\sum }_{n = 1}^{n} {T}_{m α} , α = 1 ... ... L \qquad ( 5 )$$

$${T}_{m α} = \{ \begin{matrix}{T}_{d α} - {T}_{0 m} & if {T}_{d α} > {T}_{0 m} \\ 0 & else {T}_{d α} \leq {T}_{0 m}\end{matrix} \qquad ( 6 )$$

where K is the accumulated temperature threshold of the target fish species, in ° C.·d;

$${T}_{0}^{fish}$$

is the individual developmental temperature of the target fish species, in ° C.; T₀ₘ is an assumed individual developmental temperature, in ° C.; m is a number of assumed biological zero points; f is an assumed T₀ₘ that achieves a minimum standard deviation; T_{mα} is a daily water temperature that contributes to fish development, in ° C.; α is a number of statistical years; SDₘ is a standard deviation of the accumulated temperature across all survey years, in ° C.·d; K̅ₘ̅ is an average accumulated temperature across all survey years, in ° C.·d; L is a number of years; K_{mα} is an accumulated temperature value in years, in ° C.·d; n is development time of species, in d; and T_{dα} is a river water level, in ° C.;

### BRIEF DESCRIPTION OF THE DRAWINGS

FIG. 1 is a schematic diagram of final membership functions according to the present disclosure.

FIG. 2 is diagram of validation results of a spawning ground according to the present disclosure.

FIG. 3 is a flow rate suitability curve of spawning grounds according to the present disclosure.

FIG. 4 is a flow rate continuity curve of spawning grounds according to the present disclosure.

FIG. 5 is a schematic diagram of ecological flow process and suitable ecological flow process according to the present disclosure.

FIG. 6 is a schematic diagram of critical water temperature thresholds before and after operation according to the present disclosure.

FIG. 7 is a schematic diagram of solved flow rate process and water level process according to the present disclosure.

FIG. 8 is a schematic diagram of a calculated reservoir outflow water temperature after optimized reservoir operation according to the present disclosure.

FIG. 9 is a schematic diagram of critical water temperature thresholds and accumulated temperature thresholds of a target fish species in dry, normal and wet years according to the present disclosure.

### DETAILED DESCRIPTIONS OF THE EMBODIMENTS

The technical solution of the present disclosure will be further described below with reference to the accompanying drawings.

The present disclosure discloses a reservoir ecological operation method integrating ecological flow process and water temperature process requirements of fish species, which specifically includes the following steps:
(1) establish a habitat model for a target fish species and deduce an ecological flow process of a lift history of the target fish species:

The step (1) specifically comprises the following sub-steps:
(1.1) determine the target fish species based on an analytic hierarchy process;
a systematic survey of fish resources is conducted in a study area to screen out the target fish species; population and spatial distribution characteristics of the target fish species, as well as their flow and water temperature requirements during spawning and gonadal development periods are analyzed; a determination matrix is determined based on influencing factors in a process of selecting the target fish species; assigning values to the determination matrix according to the importance of the factors; and ranking weight calculation and consistency check are performed; and steps for the ranking weight calculation are as follows: calculating a weight vector of the determination matrix, and calculating a maximum eigenvalue root of the determination matrix; and performing hierarchical sorting and consistency check;
(1.2) establish a water environment model to simulate hydrodynamic changes and water quality factor concentration changes in a main habitat river section of the target fish species;
(1.2.1) collect DEM data, topographic data, average daily flow rate, average daily water level and water temperature data, and analyze and determine a characteristic hydrological year of a study basin in combination with supplementary monitoring; establish an unsteady one-dimensional hydrodynamic model for the entire study basin under the reservoir operation based on a reservoir operating mode, and stimulate hydraulic characteristics of a downstream river course under the influence of reservoir operation in the characteristic hydrological year; and determine the hydraulic characteristics include flow rate, water level, and flow velocity, and the main habitat river section of the target fish species;
(1.2.2) establish a two-dimensional hydrodynamic model for the main habitat river section of the target fish species, take flow and water level outputs from the unsteady one-dimensional hydrodynamic model as boundary conditions for the two-dimensional hydrodynamic model, couple the unsteady one-dimensional hydrodynamic model to the two-dimensional hydrodynamic model to form a coupled hydrodynamic model, and simulate hydrodynamic changes in the main habitat river section of the target fish species;
(1.2.3) establish a one-dimensional water quality model for the entire study basin under the reservoir operation based on the reservoir operating mode, establish a two-dimensional water quality model for the main habitat river section of the target fish species, take output results of the dissolved oxygen and water temperature from the one-dimensional water quality model as boundary conditions for the two-dimensional water quality model, couple the one-dimensional water quality model to the two-dimensional water quality model to form a coupled hydrodynamic model, and simulate concentration changes of water quality factors in the main habitat river section of the target fish species;
(1.3) investigate frequencies, distribution locations, area sizes, activities, and migration patterns of spawning ground, overwintering ground, and juvenile fish rearing ground of the target fish species, and record flow rate, water temperature, water level, flow velocity, and dissolved oxygen value of the corresponding ground as validation data for a fish habitat model;
(1.4) conduct behavioral experiments on the target fish species to establish a response relationship between behavior of the target fish species and flow rate, flow velocity, water temperature, and dissolved oxygen, obtain a response curve between occurrence frequency of the target fish species and hydraulic characteristics, as well as a response curve between occurrence frequency of the target fish species and water quality factors;
(1.5) extract flow rate and flow velocity results from the hydrodynamic changes in the main habitat river section of the target fish species, extract water temperature and dissolved oxygen results from the water quality factor concentration changes in the main habitat river section, establish a membership function between the occurrence frequency of the target fish species and hydraulic characteristics, and water quality characteristics based on a fuzzy membership in combination with the flow rate and flow velocity results, the water temperature and dissolved oxygen results, the response curve between occurrence frequency of the target fish species and hydraulic characteristics, and the response curve between occurrence frequency of the target fish species and water quality factors, and establish a target fish species habitat model;
(1.6) take the flow rate and flow velocity in the hydraulic characteristics, as well as the water temperature and dissolved oxygen in the water quality factors as inputs, and the occurrence frequency of the target fish species as outputs; set the occurrence frequency of the target fish species as an objective function for optimization using a genetic algorithm, set population size, number of iterations, crossover probability, and mutation probability for the genetic algorithm, use the genetic algorithm to optimize the membership function and fuzzy rules of the fish habitat model, validate whether the occurrence frequency of the target fish species in the target fish species habitat model is consistent with occurrence frequency of the target fish species in a field survey; when the occurrence frequency of the target fish species in the target fish species habitat model is inconsistent with that in the field survey, and an error between the model and the field survey is more than 10%, the population size, number of iterations, crossover probability, and mutation probability for the genetic algorithm are adjusted, and the target fish species habitat model is optimized again until the error between the model and the field survey is less than 10%, such that a target fish species habitat model corresponding to an optimal membership and fuzzy rules is obtained, indicating that the occurrence frequency of the target fish species in the target fish species habitat model can better simulate the occurrence frequency of the target fish species in the field survey;
(1.7) take suitability index and continuity index as evaluation indicators to establish a dynamic response relationship among habitat flow rate−suitability index, and flow rate−continuity curve for the optimized target fish species habitat model;
(1.8) give comprehensive consideration to needs of the fish species in different life stages for the flow rate, especially the needs for flow rate in spawning stage and gonadal development stage, take a flow rate corresponding to an optimal suitability index and connectivity index to calculate the ecological flow process throughout the life history of the target fish species based on the dynamic response relationship among habitat flow rate−suitability index, and flow rate−continuity curve, and divide the ecological flow process into a minimum ecological flow process and a suitable ecological flow process; where an ecological flow process corresponding to a habitat restoration target of 60% is taken as the minimum ecological flow process, indicating that 60% of a target fish species habitat throughout the life history is recovered, and an ecological flow process corresponding to a habitat restoration target of 100% is taken as the suitable ecological flow process, indicating that 100% of the target fish species habitat throughout the life history is restored;
(2) calculate a critical spawning water temperature threshold and a critical gonadal development accumulated temperature threshold of the target fish species based on historical river water temperature data before dam construction, and calculate a critical spawning water temperature threshold and a critical gonadal development accumulated temperature threshold of the target fish species under an influence of current reservoir operation regulations based on river water temperature data after the dam construction;
(2.1) calculate an average daily river water temperature over many years based on the historical river water temperature data before dam construction; and calculate an average daily river water temperature downstream of the dam based on the current river water temperature data according to the current operation regulation;
(2.2) select a river water temperature at which the average daily river water temperature reaches a level stably for the first time as the critical water temperature threshold, where the level can trigger spawning behavior of the target fish species; and “reach stably for the first time” means that the water temperature has been continuously higher than the water temperature value for the next 3 consecutive days;
(2.3) determine the accumulated temperature by summing parts with temperature higher than a biological individual development temperature T₀ from a developmental stage to a mature stage in days; in the process of calculating the accumulated temperature, assuming a plurality of the biological individual development temperatures as T₀ to minimize a difference among the accumulated temperatures in each survey year; and a variation range of the individual developmental temperature of the target fish species is often determined based on a temperature

$${T}_{0}^{fish}$$

at the beginning of the developmental stage of the target fish species, usually assumed to be in a range of 0-15° C.;
a calculation formula for the accumulated temperature threshold K of the target fish species is expressed as:
K=min (K_{mf}), K_{mf} is the K_{mα} obtained when

$${T}_{0 m} = {T}_{0}^{fish}$$

in a statistical year (1)

$${T}_{0}^{fish} = {T}_{0 f} ,$$

T_{0f} is an assumed T_{mα} when SDₘ is a minimum value

$${SD}_{f} = min ( {SD}_{1} , {SD}_{2} ... {SD}_{m} ) \qquad ( 2 )$$

$${SD}_{m} = \sqrt{\frac{{\sum }_{α = 1}^{L} {( {K}_{m α} - \overline{K} )}^{2}}{L}} \qquad ( 3 )$$

$$\overline{{K}_{m}} = ( \frac{{\sum }_{α = 1}^{L} {K}_{m α}}{L} ) \qquad ( 4 )$$

$${K}_{m α} = {\sum }_{n = 1}^{n} {T}_{m α} , α = 1 ... .. L \qquad ( 5 )$$

$${T}_{m α} = \{ \begin{matrix}{T}_{d α} - {T}_{0 m} & if {T}_{d α} > {T}_{0 m} \\ 0 & else {T}_{d α} \leq {T}_{0 m}\end{matrix} \qquad ( 6 )$$

where K is the accumulated temperature threshold of the target fish species, in ° C.·d; is

$${T}_{0}^{fish}$$

the individual developmental temperature of the target fish species, in ° C.; T₀ₘ is an assumed individual developmental temperature, in ° C.; m is a number of assumed biological zero points; ƒ is an assumed T₀ₘ that achieves a minimum standard deviation; T_{mα} is a daily water temperature that contributes to fish development, in ° C.; α is a number of statistical years; SDₘ is a standard deviation of the accumulated temperature across all survey years, in ° C.·d; K̅ₘ̅ is an average accumulated temperature across all survey years, in ° C.·d; L is a number of years; K_{mα} is an accumulated temperature value in years, in ° C.·d; n is development time of species, in d; and T_{d}α is a river water level, in ° C.;
(2.4) calculate critical water temperature threshold and accumulated temperature threshold of the target fish species (2.2) and (2.3) based on a historical daily river water temperature average;
(2.5) calculate critical water temperature threshold and accumulated temperature threshold of the target fish species through the steps (2.2) and (2.3) under the influence of current reservoir operation regulations based on an average daily water temperature downstream according to the current operation regulation;
(3) establish a multi-objective reservoir operation model orienting to needs of the ecological flow process throughout a life history of the target fish species to obtain flow process and water level after the optimized reservoir operation;
(3.1) take maximum power generation, highest satisfaction rate of ecological flow of the target fish species, highest water supply satisfaction rate, and longest suitable navigation period as objective functions of the multi-objective reservoir operation model;
a) the maximum power generation

$${f}_{1} = max {\sum }_{t = 1}^{T} {\sum }_{i = 1}^{2} {N}_{i , t} Δ t \qquad ( 7 )$$

$${N}_{i , t} = {K}_{i} \cdot {Q}_{i , t}^{g} \cdot Δ {H}_{i , t} \qquad ( 8 )$$

where f₁ is an objective function for power generation; T is a total calculation period length; N_{i,t} is a power output of an i^{th} reservoir of t time steps, in kW; Δt is a unit calculation time step; Kᵢ is a hydraulic power generation coefficient of the i^{th} reservoir;

$${Q}_{i , t}^{g}$$

is a power generation flow of an i^{th} hydropower station at a period t, in m³/s; and ΔH_{i,t} is an average water level head of the i^{th} reservoir of t time steps, in m;
b) the highest satisfaction rate of ecological flow
when an outflow from the reservoir is lower than the minimum ecological flow process as stated in the step (1) throughout the life history of the target fish species, the satisfaction rate of ecological flow is 0; when the outflow from the reservoir falls within the minimum ecological flow process and the suitable ecological flow process as stated in the step (1) throughout the life history of the target fish species, the satisfaction rate of ecological flow increases with an increase in the flow rate; and when the outflow from the reservoir is greater than the suitable ecological flow process as stated in the step (1) throughout the life history of the target fish species, the satisfaction rate of ecological flow is 1;
an objective function for the satisfaction rate of ecological flow of the target fish species is as follows:

$${f}_{2} = max \frac{1}{T} {\sum }_{t = 1}^{T} {\sum }_{i = 1}^{2} {R}_{i , t} \qquad ( 9 )$$

$${R}_{i , t} = \{ \begin{matrix}0 & {Q}_{i , t}^{out} < {Q}_{t , min} \\ \frac{{Q}_{i , t}^{out} - {Q}_{t , min}}{{Q}_{t , pro} - {Q}_{t , min}} & {Q}_{t , min} < {Q}_{i , t}^{out} < {Q}_{t , pro} \\ 1 & {Q}_{t , pro} < {Q}_{i , t}^{out}\end{matrix} \qquad ( 10 )$$

where f₂ is an objective function for the satisfaction rate of ecological flow of the target fish species; Q_{t,min} and Q_{t,pro} are minimum ecological flow need and suitable ecological flow need of the target fish species at a t^{th} time period, respectively, in m³/s;

$${Q}_{i , t}^{out}$$

is an outflow of the i^{th} reservoir of t time steps, in m³/s; and T is a total calculation period length;
c) the highest water supply satisfaction rate

$${f}_{3} = max \frac{1}{T} {\sum }_{i = 1}^{T} \frac{{Q}_{sw , t}}{{Q}_{sw , t}^{demand}} \qquad ( 11 )$$

where f₃ is an objective function for the water supply satisfaction rate;

$${Q}_{sw , t}^{demand}$$

is a total water demand of t time steps, in m³/s, which is extracted from a water resources bulletin; Q_{sw,t} is a water supply flow of the t time steps, in m³/s; and T is a total calculation period length;
d) the longest suitable navigation period

$${f}_{4} = max \{ \frac{{T}_{nav}}{T} \times 100 \% \} \qquad ( 12 )$$

$${T}_{nav} = \{ t \vert {q}_{i , min}^{nav} \leq {Q}_{i , t}^{out} \leq {q}_{i , max}^{nav} , t ∈ T \} \qquad ( 13 )$$

where f₄ is an objective function for navigation; T is a total calculation period length; Tₙₐᵥ is a suitable navigation period;

$${q}_{i , min}^{nav} and {q}_{i , max}^{nav}$$

are upper and lower bounds of a suitable navigation flow range downstream of the i^{th} reservoir, in m³/s; and

$${Q}_{i , t}^{out}$$

is an outflow of the i^{th} reservoir of the t time steps, in m³/s;
(3.2) determine constraint conditions of the multi-objective reservoir operation model, and the constraint conditions include: reservoir water level constraint, reservoir capacity constraint, power output constraint, outflow constraint, and variable non-negative constraint;
a) the reservoir water level constraint

$${H}_{i , t}^{min} \leq {H}_{i , t} \leq {H}_{i , t}^{max} \qquad ( 14 )$$

where

$${H}_{i , t}^{min}$$

is a minimum water level of the i^{th} reservoir, equal to a dead storage level, in m; H_{i,t} is a water level of the i^{th} reservoir of the t time steps, in m;

$${H}_{i , t}^{max}$$

is a maximum water level of the i^{th} reservoir of the t time steps, which is a flood limit water level during a flood season and a normal storage level during a non-flood season, in m;
b) the reservoir capacity constraint

$${V}_{i , t + 1} - {V}_{i , t} = ( {Q}_{i , t}^{in} + {q}_{t} - {Q}_{i , t}^{out} ) Δ t \qquad ( 15 )$$

$${Q}_{i , t}^{out} = {Q}_{i , t}^{g} + {Q}_{i , t}^{spi} \qquad ( 16 )$$

where V_{i,t+1} and V_{i,t} are final and initial reservoir capacities of the i^{th} reservoir of the t time steps, in m³;

$${Q}_{i , t}^{in}$$

is an inflow into the i^{th} reservoir, in m³/s; qₜ is an inter-reservoir flow between cascade reservoirs, in m³/s;

$${Q}_{i , t}^{out}$$

is an outflow of the i^{th} reservoir of the t time steps, in m³/s;

$${Q}_{i , t}^{g}$$

is a hydropower diversion flow of the i^{th} reservoir, in m³/s; and

$${Q}_{i , t}^{spi}$$

is spilled water of the i^{th} reservoir, in m³/s;
c) power output constraint

$${N}_{i}^{min} \leq {N}_{i , t} \leq {N}_{i}^{max} \qquad ( 17 )$$

where

$${N}_{i}^{min} and {N}_{i}^{max}$$

are minimum and maximum power outputs of the i^{th} reservoir, respectively, in kW; and N_{i,t} is a power output of the i^{th} reservoir of the t time steps, in kW;
d) the outflow constraint

$${Q}_{i}^{min} \leq {Q}_{i , t}^{out} \leq {Q}_{i}^{max} \qquad ( 18 )$$

where

$${Q}_{i}^{min} and {Q}_{i}^{max}$$

minimum and maximum allowable outflows from the i^{th} reservoir, respectively, in m³/s; and

$${Q}_{i , t}^{out}$$

is an outflow from the i^{th} reservoir of the t time steps, in m³/s;
e) the variable non-negative constraint

$${V}_{i , t} , {N}_{i , t} , {Q}_{i , t}^{out} \geq 0 \qquad ( 19 )$$

V_{i,t} is a reservoir capacity of the i^{th} reservoir of the t time steps, in m³; N_{i,t} is a power output of the i^{th} reservoir of the t time steps, in kW; and

$${Q}_{i , t}^{out}$$

is an outflow from the i^{th} reservoir of the t time steps, in m³/s;
(3.3) optimize and solve the multi-objective reservoir operation model orienting to needs of the ecological flow process based on the third-generation non-dominated genetic algorithm (NSGA-III); and iteration stops when an objective function value does not update any longer with an increase in the number of iterations, such that an optimized flow process and water level for the reservoir are obtained;
(4) couple a water temperature model based on the multi-objective reservoir operation model orienting to needs of the ecological flow process to establish a multi-objective reservoir ecological operation model integrating both ecological flow process and water temperature process;
(4.1) collect vertical water temperature measurement data upstream of the reservoir and time series water temperature measurement data downstream of the reservoir;
(4.2) establish the water temperature model, setting initial values for longitudinal eddy viscosity, longitudinal eddy diffusion rate, Manning's coefficient and wind shelter coefficient, surface solar radiation absorption coefficient, and pure water extinction coefficient of the water temperature model, and input reservoir inflow, outflow, water level, and meteorological data corresponding to the measured water temperature data at a same time into the water temperature model; where the meteorological data include air temperature, wind speed, wind direction, dew point temperature, and shortwave radiation; and a governing equation for the water temperature model is as follows:

$$\frac{\partial UB}{\partial t} + \frac{\partial UUB}{\partial x} + \frac{\partial WUB}{\partial z} = gB sin α + g cos α B \frac{\partial η}{\partial x} - \frac{g cos α B}{ρ} {\int }_{η}^{z} \frac{\partial ρ}{\partial x} dz + \frac{1}{ρ} \frac{\partial B {τ}_{xx}}{\partial x} + \frac{1}{ρ} \frac{\partial B {τ}_{xz}}{\partial z} + {qBU}_{x} \qquad ( 20 )$$

$$0 = g cos α - \frac{1}{ρ} \frac{\partial P}{\partial z} \qquad ( 21 )$$

$${B}_{η} \frac{\partial η}{\partial } = \frac{\partial }{\partial x} {\int }_{η}^{h} UBdz - {\int }_{η}^{h} qBdz \qquad ( 22 )$$

$$\frac{\partial UB}{\partial x} + \frac{\partial WB}{\partial z} = qB \qquad ( 23 )$$

$$ρ = f ( {T}_{w} , {ϕ}_{TDS} , {ϕ}_{SS} ) \qquad ( 24 )$$

$$\frac{\partial B ϕ}{\partial t} + \frac{\partial UB ϕ}{\partial x} + \frac{\partial WB ϕ}{\partial z} - \frac{\partial ( {BD}_{x} \frac{\partial ϕ}{\partial x} )}{\partial x} - \frac{\partial ( {BD}_{z} \frac{\partial ϕ}{\partial z} )}{\partial z} = {q}_{ϕ} B + {S}_{ϕ} B \qquad ( 25 )$$

where U is a horizontal flow velocity, B is a river course width, g is an acceleration of gravity, ∂x, ∂y and ∂z denote partial derivatives with respect to x, y, and z directions, respectively, W is a vertical flow velocity, α is a river course angle, η is a water surface elevation, ρ is a density, q is a flow rate per unit width, P is a pressure, ϕ is concentration or temperature, T_{w} is a water temperature, ϕ_{TDS} is total dissolved solid concentration or salinity, OSS is an inorganic suspended solid concentration, and h is a depth;
(4.3) set an outlet of the water temperature model to 2 outlet elevations of the current operation regulation, and calculate a reservoir outflow water temperature;
(4.4) compare the calculated reservoir outflow water temperature with measured water temperature data; when an error between the calculated reservoir outflow water temperature and the measured outflow water temperature is great than 10%, the initial values for longitudinal eddy viscosity, longitudinal eddy diffusion rate, Manning's coefficient and wind shelter coefficient, surface solar radiation absorption coefficient, and pure water extinction coefficient of the water temperature model are adjusted, until a calculated error between the calculated reservoir outflow water temperature and the measured outflow water temperature is less than 10% to obtain calibrated and verified longitudinal eddy viscosity, longitudinal eddy diffusion rate, Manning's coefficient and wind shelter coefficient, surface solar radiation absorption coefficient, and pure water extinction coefficient;
(4.5) input the calibrated and verified longitudinal eddy viscosity, longitudinal eddy diffusion rate, Manning's coefficient and wind shelter coefficient, surface solar radiation absorption coefficient, and pure water extinction coefficient, and the water level and the outflow from the reservoir (that is, the optimized flow process and water level for the reservoir) calculated from the optimized multi-objective reservoir operation model in the step (3.3), as well as the corresponding meteorological data (including air temperature, wind speed, wind direction, dew point temperature, and shortwave radiation) into the water temperature model, set an outlet elevation of the current operation regulation, and calculate a reservoir outflow water temperature before the optimized reservoir operation;
(4.6) set up 8 outlets in the outlet setup for the water temperature model, where the 8 outlets include 2 outlets based on the current operation regulation, 4 outlets with elevated outlet elevation, and 2 outlets with lowered outlet elevation; the 4 elevated outlets are set as candidate outlets from March to June; the 2 lowered outlets are set as candidate outlets from October to the following January; and the 2 outlets based on the current operation regulation are used in remaining months;
(4.7) in the outlet setup for the water temperature model, use a historical daily water temperature average before the dam construction as a target; for the candidate outlets, outlet elevations for the 4 candidate outlets from March to June are optimized using the genetic algorithm, and for the 2 candidate outlets from October to the following January are optimized using the genetic algorithm, to obtain optimized outlet elevations from March to June, and from October to the following January, and outlet elevations for the remaining months are set according to the current operation regulation;
(4.8) input the flow process and water level for the reservoir calculated from the optimized multi-objective reservoir operation model orienting to needs of the ecological flow process in the step (3.3), as well as the corresponding meteorological data (including air temperature, wind speed, wind direction, dew point temperature, and shortwave radiation) into the water temperature model, and set as the optimized outlet elevations to calculate a reservoir outflow water temperature after the optimized reservoir operation;
(5) calculate an improvement difference between the critical water temperature threshold and the accumulated temperature threshold of the target fish species on arrival dates after reservoir ecological operation and those before the optimized reservoir operation, as well as a difference between the critical water temperature threshold and the accumulated temperature threshold of the target fish species after the reservoir ecological operation and those in an ideal state of the river before the dam construction;
(5.1) identify the reservoir outflow water temperature after the optimized reservoir operation as daily average river water temperature after the reservoir ecological operation, and calculate the critical water temperature threshold and accumulated temperature threshold of the target fish species after the reservoir ecological operation according to the steps (2.2) and (2.3);
(5.2) subtract an arrival date of the critical water temperature threshold under the current operation regulation (that is, conventional operation) from an arrival date of the critical water temperature threshold of the target fish species after the reservoir ecological operation to obtain an improvement difference of the critical water temperature threshold of the target fish species after the reservoir ecological operation, reflecting the improvement effect of ecological operation on the critical water temperature threshold for spawning of the target fish species; and subtract the critical water temperature threshold of the target fish species before the dam construction from the critical water temperature threshold of the target fish species after the reservoir ecological operation to obtain a difference between the critical water temperature threshold of the target fish species after the reservoir ecological operation and that in an ideal state of the river before the dam construction, reflecting a gap between the arrival date of the critical water temperature threshold for spawning of the target fish species after the reservoir ecological operation and the ideal state before the dam construction; and
(5.3) subtract the accumulated temperature threshold of the target fish species under the current operation regulation (that is, conventional operation) from the accumulated temperature threshold of the target fish species after the reservoir ecological operation to obtain an improvement difference of the accumulated temperature threshold of the target fish species after the reservoir ecological operation, reflecting the improvement effect of ecological operation on the critical water temperature threshold for gonadal development of the target fish species; and subtract the accumulated temperature threshold of the target fish species before the dam construction from the accumulated temperature threshold of the target fish species after the reservoir ecological operation to obtain a difference between the accumulated temperature threshold of the target fish species after the reservoir ecological operation and that in an ideal state of the river before the dam construction, reflecting a gap between the arrival date of the accumulated temperature threshold for gonadal development of the target fish species after the reservoir ecological operation and the ideal state before the dam construction.

### Example 1

Taking cascade reservoirs in a certain river basin as an example, this example discloses a reservoir ecological operation method integrating ecological flow process and water temperature process requirements of fish species, including the following steps:
(1) establishing a habitat model for a target fish species and deducing an ecological flow process of a lift history of the target fish species:
(1.1) determining the target fish species based on an analytic hierarchy process;
a systematic survey of fish resources is conducted in a study area to screen out the target fish species; population and spatial distribution characteristics of the target fish species, as well as their flow and water temperature requirements during spawning and gonadal development periods are analyzed; a determination matrix is determined based on influencing factors in a process of selecting the target fish species; assigning values to the determination matrix according to the importance of the factors; and ranking weight calculation and consistency check are performed; and steps for the ranking weight calculation are as follows: calculating a weight vector of the determination matrix, and calculating a maximum eigenvalue root of the determination matrix; and performing hierarchical sorting and consistency check;
Based on habitat requirements of fish species screened for the river section in Example 1, a determination matrix is constructed, a maximum eigenvalue is calculated as 17.359, and a consistency ratio (CR) is 0.013, indicating that ranking results are consistent. According to the calculation results, a ranking weight of Coreius guichenoti is a highest, as shown in Table 1, indicating that the Coreius guichenoti can better represent the habitat requirements of fish species in the river section of Example 1, therefore, it is selected as a suitable representative target fish species for the study.

TABLE 1
Ranking weights of candidate target fish species

| n | 1 | 2 | 3 | 4 | 5 | 6 |
|---|---|---|---|---|---|---|
| Species | Hypophthalmichthys | Hypophthalmichthys | elteobagrus | Pseudobagrus | Coreius | Coreius |
| name | nobilis | molitrix | vachelli | nitidus | guichenoti | heterodon |
| Ranking | 0.019 | 0.019 | 0.072 | 0.033 | 0.019 | 0.218 |
| weight | | | | | | |

| n | 7 | 8 | 9 | 10 | 11 | 12 |
|---|---|---|---|---|---|---|
| Species | Pelteobagrus | Procypris | Silurus | Pseudolaubuca | Leiocassis | Carp |
| name | fulvidraco | rabaudi | meridionalis | engraulis | longirostris | |
| Ranking | 0.051 | 0.019 | 0.019 | 0.132 | 0.019 | 0.099 |
| weight | | | | | | |

| n | 13 | 14 | 15 | 16 | 17 |
|---|---|---|---|---|---|
| Species | Rhodeus | Culter | Hemiculter | Ctenopharyngodon | Saurogobio |
| name | ocellatus | alburnus | leucisculus | idellus | dabryi |
| Ranking | 0.033 | 0.172 | 0.033 | 0.019 | 0.019 |
| weight | | | | | |

(1.2) establishing a water environment model to simulate hydrodynamic changes and water quality factor concentration changes in a main habitat river section of the target fish species;
(1.2.1) collecting DEM data, topographic data, average daily flow rate, average daily water level and water temperature data, and analyzing and determining a characteristic hydrological year of a study basin in combination with supplementary monitoring; establishing an unsteady one-dimensional hydrodynamic model for the entire study basin under the reservoir operation based on a reservoir operating mode, and simulating hydraulic characteristics of a downstream river course under the influence of reservoir operation in the characteristic hydrological year; where the hydraulic characteristics include flow rate, water level, and flow velocity, and the main habitat river section of the target fish species is then determined;
(1.2.2) establishing a two-dimensional hydrodynamic model for the main habitat river section of the target fish species, taking output results of the flow rate and water level from the unsteady one-dimensional hydrodynamic model as boundary conditions for the two-dimensional hydrodynamic model, coupling the unsteady one-dimensional hydrodynamic model to the two-dimensional hydrodynamic model to form a coupled hydrodynamic model, and simulating hydrodynamic changes in the main habitat river section of the target fish species;
(1.2.3) establishing a one-dimensional water quality model for the entire study basin under the reservoir operation based on the reservoir operating mode, establishing a two-dimensional water quality model for the main habitat river section of the target fish species, taking output results of the dissolved oxygen and water temperature from the one-dimensional water quality model as boundary conditions for the two-dimensional water quality model, coupling the one-dimensional water quality model to the two-dimensional water quality model to form a coupled hydrodynamic model, and simulating concentration changes in water quality factors in the main habitat river section of the target fish species;
In the unsteady one-dimensional hydrodynamic model, the average daily flow rate is used as boundary input conditions, and the average daily water level as boundary input conditions; dissolved oxygen and water temperature are taken as two parameters for the water quality model; initial velocity conditions for the flow rate calculation is given in a form of cold start (u=0 m/s), and daily flow rate and water level value are assigned to inflow and outflow nodes at the same time; after 3 days of calculation, the impact of cold start can be eliminated; initial values for water quality parameters are determined based on observed values; and by combining them with the hydrodynamic model, errors from the hydrodynamic cold start can also be eliminated after 2-3 days of calculation, and calculation results are saved as a hot-start file for formal calculations.

A two-dimensional water environment model uses the results of the unsteady one-dimensional hydrodynamic model as input conditions, the average daily flow rate is taken as boundary conditions for an upstream inlet, the average water level is taken as control conditions for a downstream outlet, and average daily concentration is taken as input conditions for the dissolved oxygen and temperature.

Initial parameters of the model are set as follows:

Initial values for parameters of the model are determined as follows based on actual measurements, calculations, and literature review:
(1) a time step of the model is set to 60 s, and a spatial step thereof is set to 600 m;
(2) since bottom sediment, meandering, and bank slope of the river in the study ware are similar, a Manning's roughness coefficient ranges from 0.04 to 0.05;
(3) a BOD carbonization degradation rate ranges from 0.04 to 0.08;
(4) an atmospheric reoxygenation rate is calculated using a Churchill formula, K₂=(0.746U^{2.695}/H^{3.085}J^{0.823})1.024^{t-20}, where U is an average flow rate, H is an average water depth; and J is a water surface slope;
time steps for the water hydrodynamic and water quality model are set to 60 s, spatial steps thereof are set to 800 m, a Manning's coefficient (n) for bottom roughness is between 0.052-0.042 from upstream to downstream, a carbonization degradation rate of organic matter is 0.06/d, a nitrification degradation rate is 0.18/d, and an atmospheric reoxygenation coefficient is a calculated value;
(1.3) investigating frequencies, distribution locations, area sizes, activities, and migration patterns of spawning ground, overwintering ground, and juvenile fish rearing ground of the target fish species, and recording flow rate, water temperature, water level, flow velocity, and dissolved oxygen value of each of the corresponding grounds as validation data for a fish habitat model;
(1.4) conducting behavioral experiments on the target fish species to establish a response relationship between behavior of the target fish species and flow rate, flow velocity, water temperature, and dissolved oxygen, obtaining a response curve between occurrence frequency of the target fish species and hydraulic characteristics, as well as a response curve between occurrence frequency of the target fish species and water quality factors;
(1.5) extracting flow rate and flow velocity results from the hydrodynamic changes in the main habitat river section of the target fish species, extracting water temperature and dissolved oxygen results from the water quality factor concentration changes in the main habitat river section, establishing a membership function between the occurrence frequency of the target fish species and hydraulic characteristics, and water quality characteristics based on a fuzzy membership in combination with the flow rate and flow velocity results, the water temperature and dissolved oxygen results, the response curve between occurrence frequency of the target fish species and hydraulic characteristics, and the response curve between occurrence frequency of the target fish species and water quality factors, and establishing a target fish species habitat model;
(1.6) taking the flow rate and flow velocity in the hydraulic characteristics, as well as the water temperature and dissolved oxygen in the water quality factors as inputs, and the occurrence frequency of the target fish species as outputs; setting the occurrence frequency of the target fish species as an objective function for optimization using a genetic algorithm, setting population size, number of iterations, crossover probability, and mutation probability for the genetic algorithm, optimizing the membership function and fuzzy rules of the fish habitat model using the genetic algorithm;

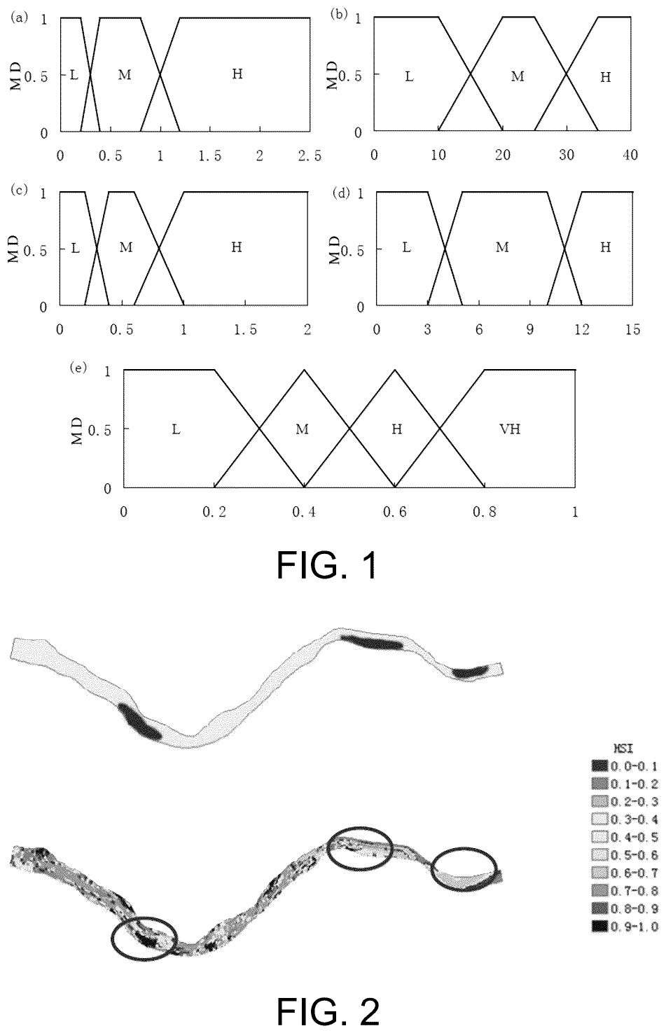

Two types of living environments for the Coreius guichenoti, that is, spawning ground and overwintering ground, were selected to carry out the suitability evaluation. Taking the spawning ground as an example, fuzzy rules were optimized using the genetic algorithm based on parameters outputted from the water environment model, final membership functions were shown in FIG. 1, and the fuzzy rules were itemized in Table 2; in FIG. 1, membership degrees of all parameters are as follows: (a) water depth, (b) flow velocity, (c) water temperature, (d) dissolved oxygen, (e) habitat suitability index (HSI), where MD=Membership Degree, L=Low Suitability, M=Medium Suitability, H=High Suitability, and VH=Very High Suitability.

TABLE 2
Fuzzy rules

| Water depth | Flow rate | Water temperature | Spawning ground |
|---|---|---|---|
| L | L | L | L |
| L | L | M | L |
| L | L | H | L |
| L | M | L | M |
| L | M | M | H |
| L | M | H | M |
| M | L | L | M |
| M | L | M | H |
| M | L | H | M |
| M | M | L | H |
| M | M | M | VH |
| M | M | H | H |
| M | H | L | M |
| M | H | M | H |
| M | H | H | M |
| H | M | L | M |
| H | M | M | H |
| H | M | H | M |
| H | H | L | L |
| H | H | M | M |
| H | H | H | L |

validating whether the occurrence frequency of the target fish species in the target fish species habitat model is consistent with occurrence frequency of the target fish species in a field survey; when the occurrence frequency of the target fish species in the target fish species habitat model is inconsistent with that in the field survey, and an error between the model and the field survey is more than 10%, the population size, number of iterations, crossover probability, and mutation probability for the genetic algorithm are adjusted, and the target fish species habitat model is optimized again until the error between the model and the field survey is less than 10%, such that a target fish species habitat model corresponding to an optimal membership and fuzzy rules is obtained, indicating that the occurrence frequency of the target fish species in the target fish species habitat model can better simulate the occurrence frequency of the target fish species in the field survey;

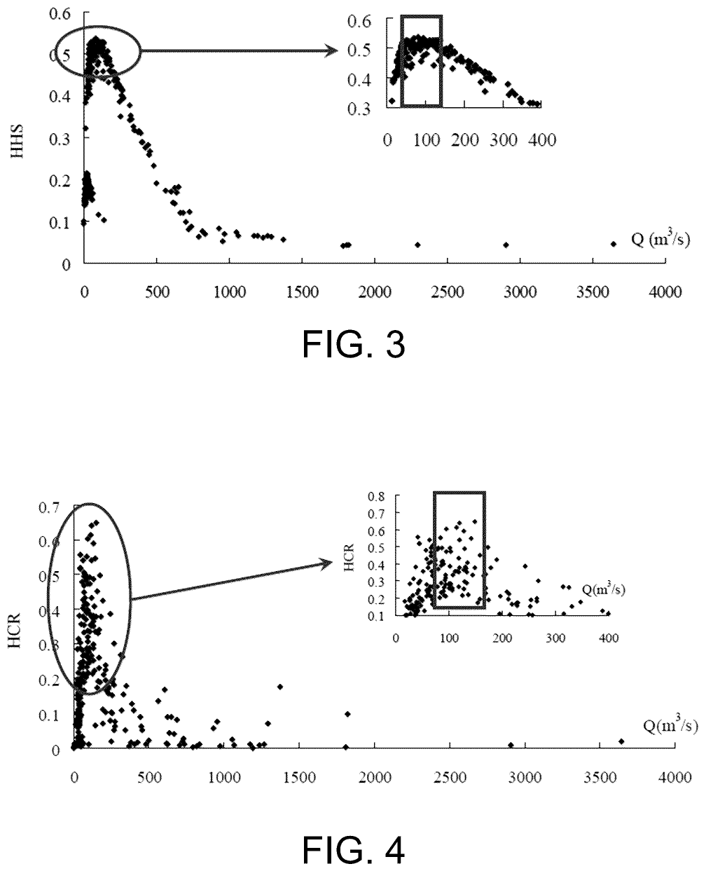

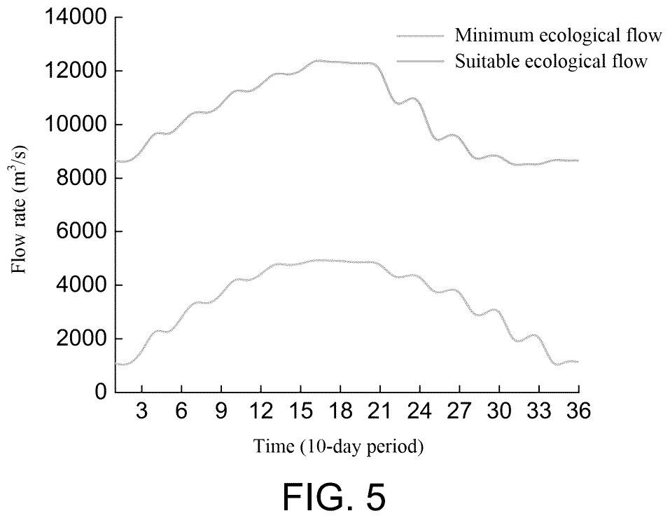

The habitat model for the target fish species was further validated using Baihetan-Zhutuo River Section of the Jinsha River. During the fish spawning period, the suitability of the Baihetan-Zhutuo River Section as a spawning ground reached above 0.3 for the vast majority of the time, and the survey identified three traditional fish spawning grounds along the river section, as shown in FIG. 2. The spawning grounds in the section, that is, Fotan, Xinshi, and Pingshan, were the first to show a suitability greater than 0.5 (in early March), and maintained a high suitability during the fish spawning and reproduction periods. The validation results indicated that simulation results of the habitat model were reliable. FIG. 3 shows the validation results of spawning grounds, with the survey results shown above and the simulation results shown below in FIG. 2.
(1.7) taking suitability index and continuity index as evaluation indicators to establish a dynamic response relationship among habitat flow rate−suitability index, and flow rate−continuity curve for the optimized target fish species habitat model; a flow rate suitability curve of spawning grounds is shown in FIG. 3; and a flow rate continuity curve of spawning grounds is shown in FIG. 4.
(1.8) giving comprehensive consideration to needs of the fish species in different life stages for the flow rate, especially the needs for flow rate in spawning stage and gonadal development stage, taking a flow rate corresponding to an optimal suitability index and connectivity index to calculate the ecological flow process throughout the life history of the target fish species based on the dynamic response relationship among habitat suitability rate−connectivity index−flow rate, and dividing the ecological flow process into a minimum ecological flow process and a suitable ecological flow process; where an ecological flow process corresponding to a habitat restoration target of 60% is taken as the minimum ecological flow process, indicating that 60% of a target fish species habitat throughout the life history is recovered, and an ecological flow process corresponding to a habitat restoration target of 100% is taken as the suitable ecological flow process, indicating that 100% of the target fish species habitat throughout the life history of the target fish species is restored, as shown in FIG. 5;
(2) calculating a critical spawning water temperature threshold and a critical gonadal development accumulated temperature threshold of the target fish species based on historical river water temperature data before dam construction, and calculating a critical spawning water temperature threshold and a critical gonadal development accumulated temperature threshold of the target fish species under an influence of current reservoir operation regulations based on river water temperature data after the dam construction;
(2.1) calculating an average daily river water temperature over many years based on the historical river water temperature data before dam construction; and calculating an average daily river water temperature downstream of the dam based on the current river water temperature data according to the current operation regulation;
(2.2) selecting a river water temperature at which the average daily river water temperature reaches a level stably for the first time as the critical water temperature threshold, where the level can trigger spawning behavior of the target fish species; and “reach stably for the first time” means that the water temperature has been continuously higher than the water temperature value for the next 3 consecutive days;
(2.3) determining the accumulated temperature by summing parts with temperature higher than a biological individual development temperature T₀ from a developmental stage to a mature stage in days; in the process of calculating the accumulated temperature, assuming a plurality of the biological individual development temperatures as T₀ to minimize a difference among the accumulated temperatures in each survey year; and a variation range of the individual developmental temperature

$${T}_{0}^{fish}$$

of the target fish species is often determined based on a temperature at the beginning of the developmental stage of the target fish species, usually assumed to be in a range of 0-15° C.;
a calculation formula for the accumulated temperature threshold K of the target fish species is expressed as:
K=min (K_{mf}), K_{mf} is the K_{mα} obtained when

$${T}_{0 m} = {T}_{0}^{fish}$$

in a statistical year (1)

$${T}_{0}^{fish} = {T}_{0 f} ,$$

T_{0f} is an assumed T_{mα} when SDₘ is a minimum value

$${SD}_{f} = min ( {SD}_{1} , {SD}_{2} … {SD}_{m} ) \qquad ( 2 )$$

$${SD}_{m} = \sqrt{\frac{{\sum }_{α = 1}^{L} {( {K}_{m α} - \overline{K} )}^{2}}{L}} \qquad ( 3 )$$

$$\overline{{K}_{m}} = ( \frac{{\sum }_{α = 1}^{L} {K}_{m α}}{L} ) \qquad ( 4 )$$

$${K}_{m α} = {\sum }_{n = 1}^{n} {T}_{m α} , α = 1 ……L \qquad ( 5 )$$

$${T}_{m α} = \{ \begin{matrix}{T}_{d α} > {T}_{0 m} & if {T}_{d α} > {T}_{0 m} \\ 0 & else {T}_{d α} \leq {T}_{0 m}\end{matrix} \qquad ( 6 )$$

where K is the accumulated temperature threshold of the target fish species, in ° C.·d; is

$${T}_{0}^{fish}$$

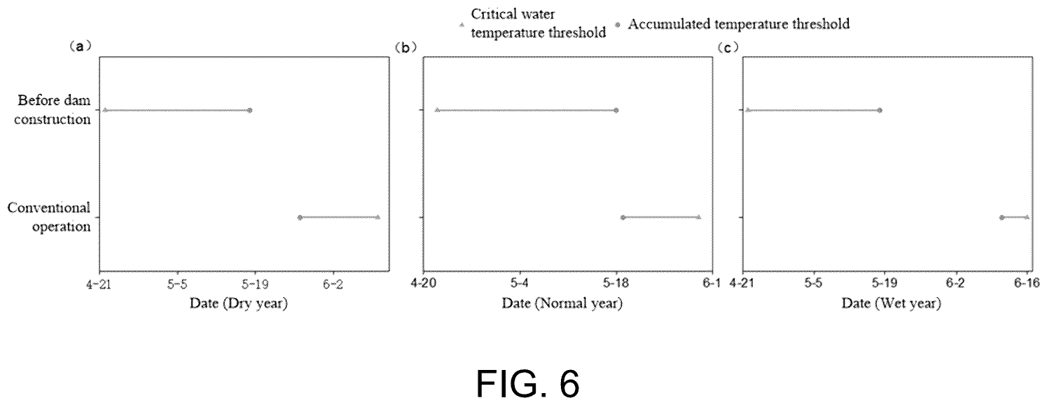

the individual developmental temperature of the target fish species, in ° C.; T₀ₘ is an assumed individual developmental temperature, in ° C.; m is a number of assumed biological zero points; ƒ is an assumed T₀ₘ that achieves a minimum standard deviation; T_{mα} is a daily water temperature that contributes to fish development, in ° C.; α is a number of statistical years; SDₘ is a standard deviation of the accumulated temperature across all survey years, in ° C.·d; Kₘ is an average accumulated temperature across all survey years, in ° C.·d; L is a number of years; K_{mα} is an accumulated temperature value in years, in ° C.·d; n is development time of species, in d; and T_{d}α is a river water level, in ° C.;
(2.4) calculating critical water temperature threshold and accumulated temperature threshold of the target fish species (2.2) and (2.3) based on a historical daily river water temperature average;
(2.5) calculate critical water temperature threshold and accumulated temperature threshold of the target fish species through the steps (2.2) and (2.3) under the influence of current reservoir operation regulations based on an average daily water temperature downstream according to the current operation regulation;
as shown in FIG. 6, the calculation indicated that critical water temperature threshold for the target fish species before the dam construction reached on April 22, and the accumulated temperature threshold therefor reached on May 18; and under the current reservoir operation regulations, the critical water temperature threshold reached on May 30, June 10, and June 16 for dry, normal, and wet years, respectively, while the accumulated temperature threshold reached on May 19, May 27, and June 11, respectively;
(3) establishing a multi-objective reservoir operation model orienting to needs of the ecological flow process throughout a life history of the target fish species to obtain flow process and water level after the optimized reservoir operation;
(3.1) taking maximum power generation, highest satisfaction rate of ecological flow of the target fish species, highest water supply satisfaction rate, and longest suitable navigation period as objective functions of the multi-objective reservoir operation model;
a) the maximum power generation

$${f}_{1} = max {\sum }_{t = 1}^{T} {\sum }_{i = 1}^{2} {N}_{i , t} Δ t \qquad ( 7 )$$

$${N}_{i , t} = {K}_{i} \cdot {Q}_{i , t}^{g} \cdot Δ {H}_{i , t} \qquad ( 8 )$$

where f₁ is an objective function for power generation; T is a total calculation period length; N_{i,t} is a power output of an i^{th} reservoir of t time steps, in kW; Δt is a unit calculation time step; Kᵢ is a hydraulic power generation coefficient of the i^{th} reservoir;

$${Q}_{i , t}^{g}$$

is a power generation flow of an i^{th} hydropower station at a time period t, in m³/s; and ΔH_{i,t} is an average water level head of the i^{th} reservoir of the t time steps, in m;
b) the highest satisfaction rate of ecological flow
when an outflow from the reservoir is lower than the minimum ecological flow process as stated in the step (1) throughout the life history of the target fish species, the satisfaction rate of ecological flow is 0; when the outflow from the reservoir falls within the minimum ecological flow process and the suitable ecological flow process as stated in the step (1) throughout the life history of the target fish species, the satisfaction rate of ecological flow increases with an increase in the flow rate; and when the outflow from the reservoir is greater than the suitable ecological flow process as stated in the step (1) throughout the life history of the target fish species, the satisfaction rate of ecological flow is 1;
an objective function for the satisfaction rate of ecological flow of the target fish species is as follows:

$${f}_{2} = max \frac{1}{T} {\sum }_{t = 1}^{T} {\sum }_{i = 1}^{2} {R}_{i , t} \qquad ( 9 )$$

$${R}_{i , t} = \{ \begin{matrix}0 & {Q}_{i , t}^{out} < {Q}_{t , min} \\ \frac{{Q}_{i , t}^{out} - {Q}_{t , min}}{{Q}_{t , pro} - {Q}_{t , min}} & {Q}_{t , min} < {Q}_{i , t}^{out} < {Q}_{t , pro} \\ 1 & {Q}_{t , pro} < {Q}_{i , t}^{out}\end{matrix} \qquad ( 10 )$$

where f₂ is an objective function for the satisfaction rate of ecological flow of the target fish species; Q_{t,min} and Q_{t,pro} are minimum ecological flow need and suitable ecological flow need of the target fish species at a t^{th} time period, respectively, in m³/s;

$${Q}_{i , t}^{out}$$

is an outflow of the i^{th} reservoir of t time steps, in m³/s; and T is a total calculation period length;
c) the highest water supply satisfaction rate

$${f}_{3} = max \frac{1}{T} {\sum }_{i = 1}^{T} \frac{{Q}_{sw , t}}{{Q}_{sw , t}^{demand}} \qquad ( 11 )$$

where f₃ is an objective function for the water supply satisfaction rate;

$${Q}_{sw , t}^{demand}$$

is a total water demand of t time steps, in m³/s, which is extracted from a water resources bulletin; Q_{sw,t} is a water supply flow of the t time steps, in m³/s; and T is a total calculation period length;
d) the longest suitable navigation period

$${f}_{4} = max \{ \frac{{T}_{nav}}{T} \times 100 \% \} \qquad ( 12 )$$

$${T}_{nav} = \{ t \vert {q}_{i , min}^{nav} \leq {Q}_{i , t}^{out} \leq {q}_{i , max}^{nav} , t ∈ T \} \qquad ( 13 )$$

where f₄ is an objective function for navigation; T is a total calculation period length; Tₙₐᵥ is a suitable navigation period;

$${q}_{i , min}^{n a v} and {q}_{i , max}^{n a v}$$

are upper and lower bounds of a suitable navigation flow range downstream of the i^{th} reservoir, in m³/s; and

$${Q}_{i , t}^{out}$$

is an outflow of the i^{th} reservoir of the t time steps, in m³/s;
(3.2) determining constraint conditions of the multi-objective reservoir operation model, and the constraint conditions include: reservoir water level constraint, reservoir capacity constraint, power output constraint, outflow constraint, and variable non-negative constraint;
a) the reservoir water level constraint

$${H}_{i , t}^{min} \leq {H}_{i , t} \leq {H}_{i , t}^{max} \qquad ( 14 )$$

where

$${H}_{i , t}^{min}$$

is a minimum water level of the i^{th} reservoir, equal to a dead storage level, in m; H_{i,t} is a water level of the i^{th} reservoir of the t time steps, in m;

$${H}_{i , t}^{max}$$

is a maximum water level of the i^{th} reservoir of the t time steps, which is a flood limit water level during a flood season and a normal storage level during a non-flood season, in m;
b) the reservoir capacity constraint

$${V}_{i , t + 1} - {V}_{i , t} = ( {Q}_{i , t}^{in} + {q}_{t} - {Q}_{i , t}^{out} ) Δ t \qquad ( 15 )$$

$${Q}_{i , t}^{out} = {Q}_{i , t}^{g} + {Q}_{i , t}^{spi} \qquad ( 16 )$$

where V_{i,t+1} and V_{i,t} are final and initial reservoir capacities of the i^{th} reservoir of the t time steps, in m³;

$${Q}_{i , t}^{in}$$

is an inflow into the i^{th} reservoir, in m³/s; qₜ is an inter-reservoir flow between cascade reservoirs, in m³/s;

$${Q}_{i , t}^{out}$$

is an outflow of the i^{th} reservoir of the t time steps, in m³/s;

$${Q}_{i , t}^{g}$$

is a hydropower diversion flow of the i^{th} reservoir, in m³/s; and

$${Q}_{i , t}^{spi}$$

is spilled water of the i^{l}i^{th} reservoir, in m³/s;
c) power output constraint

$${N}_{i}^{min} \leq {N}_{i , t} \leq {N}_{i}^{max} \qquad ( 17 )$$

where

$${N}_{i}^{min} and {N}_{i}^{max}$$

are minimum and maximum power outputs of the i^{th} reservoir, respectively, in kW; and N_{i,t} is a power output of the i^{th} reservoir of the t time steps, in kW;
d) the outflow constraint

$${Q}_{i}^{min} \leq {Q}_{i , t}^{o u t} \leq {Q}_{i}^{max} \qquad ( 18 )$$

where

$${Q}_{i}^{min} and {Q}_{i}^{max}$$

minimum and maximum allowable outflows from the i^{th} reservoir, respectively, in m³/s; and

$${Q}_{i , t}^{out}$$

is an outflow from the i^{th} reservoir of the t time steps, in m/s;
e) the variable non-negative constraint

$${V}_{i , t} , {N}_{i , t} , {Q}_{i , t}^{o u t} \geq 0 \qquad ( 19 )$$

V_{i,t} is a reservoir capacity of the i^{th} reservoir of the t time steps, in m³; N_{i,t} is a power output of the i^{th} reservoir of the t time steps, in kW; and

$${Q}_{i , t}^{out}$$

is an outflow from the i^{th} reservoir of the t time steps, in m³/s;
(3.3) optimizing and solving the multi-objective reservoir operation model orienting to needs of the ecological flow process based on a third-generation non-dominated genetic algorithm (NSGA-III); and iteration stops when an objective function value does not update any longer with an increase in the number of iterations, such that an optimized flow process and water level for the reservoir are obtained;

The study involves Xiluodu and Xiangjiaba cascade hydropower stations in China, which are located in lower reaches of Jinsha River, the most abundant hydropower resource area in the Yangtze River Basin. The primary functions of the cascade reservoirs are hydropower generation, water supply, navigation, and downstream flood control.

The inflow data of Xiluodu Reservoir from 2005 to 2020 was used. Based on a definition of typical hydrological years, years with a total flow ranking above 25%, between 25% and 75%, and below 75% are defined as wet years, normal years, and dry years, respectively. The years 2015 (ranking 75%), 2019 (ranking 50%), and 2018 (ranking 25%) were identified as dry, normal, and wet years, respectively.

A simulation period was from January 1 to December 31. In the multi-objective reservoir operation model, the simulation period was divided into 73 segments, each with a duration of 5 days. Decision-making variables were the average reservoir water level for every 5 days (Hi,t, where i=1, 2; t=1, 2, . . . , 73) and the average water supply flow for every 10 or 11 days (, t=1, 2, . . . , 36).

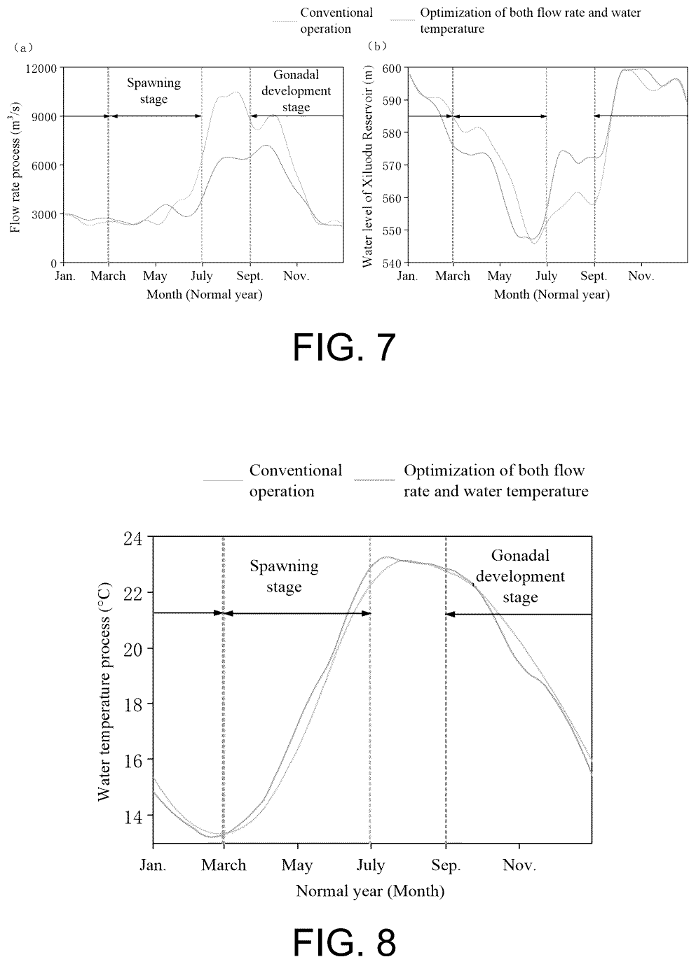

The multi-objective reservoir operation model orienting to needs of the ecological flow process are optimized and solved based on the third-generation non-dominated genetic algorithm (NSGA-III); the parameters were set as follows: a distribution index for crossover n_{c} was set to 20, and a distribution index for mutation nm was also set to 20. A crossover probability ρ_{c} was set to 1, and a mutation probability ρₘ was set to 1/D, where D is a number of decision variables. A population size was set to 400, and a maximum number of function evaluations was set to 50000. The calculated flow process and water level process were shown in FIG. 7.
(4) couple a water temperature model based on the multi-objective reservoir operation model orienting to needs of the ecological flow process to establish a multi-objective reservoir ecological operation model integrating both the ecological flow process and the water temperature process;
(4.1) collecting vertical water temperature measurement data upstream of the reservoir and time series water temperature measurement data downstream of the reservoir;
(4.2) establishing the water temperature model, setting initial values for longitudinal eddy viscosity, longitudinal eddy diffusion rate, Manning's coefficient and wind shelter coefficient, surface solar radiation absorption coefficient, and pure water extinction coefficient of the water temperature model, and inputting reservoir inflow, outflow, water level, and meteorological data corresponding to the measured water temperature data at a same time into the water temperature model; where the meteorological data include air temperature, wind speed, wind direction, dew point temperature, and shortwave radiation; and a governing equation for the water temperature model is as follows:

$$\frac{\partial U B}{\partial t} + \frac{\partial U U B}{\partial x} + \frac{\partial W U B}{\partial z} = gB sin α + g cos α B \frac{\partial η}{\partial x} - \frac{g cos α B}{ρ} {\int }_{η}^{z} \frac{\partial ρ}{\partial x} dz + \frac{1}{ρ} \frac{\partial B {τ}_{xx}}{\partial x} + \frac{1}{ρ} \frac{\partial B {τ}_{xz}}{\partial z} + q B {U}_{x} \qquad ( 20 )$$

$$0 = g cos α - \frac{1}{ρ} \frac{\partial P}{\partial z} \qquad ( 21 )$$

$${B}_{η} \frac{\partial η}{\partial } = \frac{\partial }{\partial x} {\int }_{η}^{h} U B d z - {\int }_{η}^{h} q Bdz \qquad ( 22 )$$

$$\frac{\partial U B}{\partial x} + \frac{\partial W B}{\partial z} = qB \qquad ( 23 )$$

$$ρ = f ( {T}_{w} , {ϕ}_{TDS} , {ϕ}_{ss} ) \qquad ( 24 )$$

$$\frac{\partial B ϕ}{\partial t} + \frac{\partial U B ϕ}{\partial x} + \frac{\partial W B ϕ}{\partial z} - \frac{\partial ( B {D}_{x} \frac{\partial ϕ}{\partial x} )}{\partial x} - \frac{\partial ( B {D}_{z} \frac{\partial ϕ}{\partial z} )}{\partial z} = {q}_{ϕ} B + {S}_{ϕ} B \qquad ( 25 )$$

where U is a horizontal flow velocity, B is a river course width, g is an acceleration of gravity, ∂x, ∂y and ∂z denote partial derivatives with respect to x, y, and z directions, respectively, W is a vertical flow velocity, α is a river course angle, η is a water surface elevation, ρ is a density, q is a flow rate per unit width, P is a pressure, ϕ is concentration or temperature, T_{w} is a water temperature, ϕ_{TDS} is total dissolved solid concentration or salinity, ϕₛₛ is an inorganic suspended solid concentration, and h is a depth;
(4.3) setting an outlet of the water temperature model to 2 outlet elevations of the current operation regulation, and calculating a reservoir outflow water temperature;
(4.4) comparing the calculated reservoir outflow water temperature with measured water temperature data; when an error between the calculated reservoir outflow water temperature and the measured outflow water temperature is great than 10%, the initial values for longitudinal eddy viscosity, longitudinal eddy diffusion rate, Manning's coefficient and wind shelter coefficient, surface solar radiation absorption coefficient, and pure water extinction coefficient of the water temperature model are adjusted, until a calculated error between the calculated reservoir outflow water temperature and the measured outflow water temperature is less than 10% to obtain calibrated and verified longitudinal eddy viscosity, longitudinal eddy diffusion rate, Manning's coefficient and wind shelter coefficient, surface solar radiation absorption coefficient, and pure water extinction coefficient;

The longitudinal eddy viscosity, longitudinal eddy diffusion rate, Manning's coefficient and wind shelter coefficient directly affected fluid dynamics and heat transfer. The surface solar radiation absorption coefficient, and pure water extinction coefficient directly affected temperature, thus affecting the fluid dynamics. The above coefficients must be calibrated in the model. Results of model calibration are shown in Table 3.

TABLE 3

| Parameter | Name | Unit | Value |
|---|---|---|---|
| Longitudinal eddy viscosity | [AX] | m²/s | 1 |
| Longitudinal eddy diffusion rate | [DX] | m²/s | 1 |
| Manning's coefficient | [FRICT] | — | 0.001 |
| Wind shelter coefficient | [WSC] | — | 0.7 |
| Surface solar radiation | [BETA] | — | 0.45 |
| absorption coefficient | | | |
| Pure water extinction coefficient | [EXH20] | m⁻¹ | 0.45 |

(4.5) inputting the calibrated and verified longitudinal eddy viscosity, longitudinal eddy diffusion rate, Manning's coefficient and wind shelter coefficient, surface solar radiation absorption coefficient, and pure water extinction coefficient, and the water level and the outflow from the reservoir (that is, the optimized flow process and water level for the reservoir) calculated from the optimized multi-objective reservoir operation model in the step (3.3), as well as the corresponding meteorological data (including air temperature, wind speed, wind direction, dew point temperature, and shortwave radiation) into the water temperature model, setting an outlet elevation of the current operation regulation, and calculating reservoir outflow water temperatures before and after the optimized reservoir operation;
(4.6) setting up 8 outlets in the outlet setup for the water temperature model, where the 8 outlets include 2 outlets based on the current operation regulation, 4 outlets with elevated outlet elevation, and 2 outlets with lowered outlet elevation; the 4 elevated outlets are set as candidate outlets from March to June; the 2 lowered outlets are set as candidate outlets from October to the following January; and the 2 outlets based on the current operation regulation are used in remaining months;
(4.7) in the outlet setup for the water temperature model, using a historical daily water temperature average before the dam construction as a target; for the candidate outlets, outlet elevations for the 4 candidate outlets from March to June are optimized using the genetic algorithm, and for the 2 candidate outlets from October to the following January are optimized using the genetic algorithm, to obtain optimized outlet elevations from March to June, and from October to the following January, and outlet elevations for the remaining months are set according to the current operation regulation;
(4.8) inputting the flow process and water level for the reservoir calculated from the optimized multi-objective reservoir operation model orienting to needs of the ecological flow process in the step (3.3), as well as the corresponding meteorological data (including air temperature, wind speed, wind direction, dew point temperature, and shortwave radiation) into the water temperature model, and setting as the optimized outlet elevations to calculate a reservoir outflow water temperature after the optimized reservoir operation, as shown in FIG. 8;
(5) calculating an improvement difference between the critical water temperature threshold and the accumulated temperature threshold of the target fish species on arrival dates after reservoir ecological operation and those before the optimized reservoir operation, as well as a difference between the critical water temperature threshold and the accumulated temperature threshold of the target fish species after the reservoir ecological operation and those in an ideal state of the river before the dam construction;
(5.1) identifying the reservoir outflow water temperature after the optimized reservoir operation as daily average river water temperature after the reservoir ecological operation, and calculating critical water temperature threshold and accumulated temperature threshold of the target fish species after the reservoir ecological operation according to the steps (2.2) and (2.3);
(5.2) subtracting an arrival date of the critical water temperature threshold under the current operation regulation (that is, conventional operation) from an arrival date of the critical water temperature threshold of the target fish species after the reservoir ecological operation to obtain an improvement difference of the critical water temperature threshold of the target fish species after the reservoir ecological operation, reflecting the improvement effect of ecological operation on the critical water temperature threshold for spawning of the target fish species; and subtracting the critical water temperature threshold of the target fish species before the dam construction from the critical water temperature threshold of the target fish species after the reservoir ecological operation to obtain a difference between the critical water temperature threshold of the target fish species after the reservoir ecological operation and that in an ideal state of the river before the dam construction, reflecting a gap between the arrival date of the critical water temperature threshold for spawning of the target fish species after the reservoir ecological operation and the ideal state before the dam construction; and
(5.3) subtracting the accumulated temperature threshold of the target fish species under the current operation regulation (that is, conventional operation) from the accumulated temperature threshold of the target fish species after the reservoir ecological operation to obtain an improvement difference of the accumulated temperature threshold of the target fish species after the reservoir ecological operation, reflecting the improvement effect of ecological operation on the critical water temperature threshold for gonadal development of the target fish species; and subtracting the accumulated temperature threshold of the target fish species before the dam construction from the accumulated temperature threshold of the target fish species after the reservoir ecological operation to obtain a difference between the accumulated temperature threshold of the target fish species after the reservoir ecological operation and that in an ideal state of the river before the dam construction, reflecting a gap between the arrival date of the accumulated temperature threshold for gonadal development of the target fish species after the reservoir ecological operation and the ideal state before the dam construction.

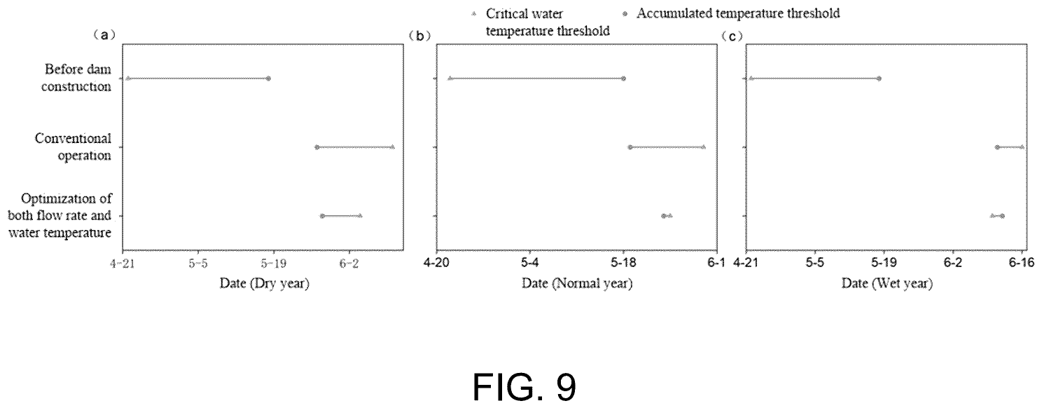

FIG. 9 shows critical water temperature thresholds and accumulated temperature thresholds of a target fish species in dry, normal and wet years. Critical spawning water temperature thresholds of the target fish species were advanced by 5, 6 and 6 days in the dry, normal and wet years, respectively; and critical gonadal development accumulated temperature threshold of the target fish species were delayed by 5 days, 1 day and 1 day, respectively. The critical water temperature threshold and the accumulated temperature threshold were matched as much as possible again to promote the fish spawning.

Through the reservoir ecological operation method integrating ecological flow process and water temperature process requirements of fish species provided by the present disclosure, the hydropower generation of the cascade reservoirs increased by 1.78% compared to conventional operation scenarios, the water supply satisfaction rate and the navigation satisfaction rate were both maintained above 98%, and the ecological flow satisfaction rate for the target fish species increased by 4.02%. The water temperature requirements for fish spawning and gonadal development were improved, with the critical water temperature threshold in a typical normal year advanced by 6 days, and the accumulated temperature threshold delayed by 1 day.

Beneficial effects: Compared with prior art, the present disclosure has the following significant advantages: on the basis of guaranteeing the economic benefits of power generation, water supply, and navigation, the present disclosure considers both needs for flow process and water temperature of the target fish species in different stages of lift history, especially needs of fish in spawning stage and gonadal development stage, thereby achieving the maximum protection of fish in a river more effectively.

The present disclosure provides a reservoir ecological operation method integrating ecological flow process and water temperature process requirements of fish species, the description above is merely the preferred embodiments of the present disclosure, it should be pointed out that those of ordinary skill in the art can also make some improvements and modifications without departing from the principle of the present disclosure, and these improvements and modifications should also fall within the scope of protection of the present disclosure. All the components not specified in this embodiment can be implemented by using the prior art.

What is claimed is:

1. A reservoir ecological operation method integrating ecological flow process and water temperature process requirements of fish species, comprising the following steps:
(1) establishing a habitat model for a target fish species and deducing an ecological flow process of a lift history of the target fish species; wherein
the step (1) specifically comprises the following sub-steps:
(1.1) determining the target fish species based on an analytic hierarchy process;
(1.2) establishing a water environment model to simulate hydrodynamic changes and water quality factor concentration changes in a main habitat river section of the target fish species;
wherein the step (1.2) specifically comprises the following sub-steps:
(1.2.1) collecting DEM data, topographic data, average daily flow rate, average daily water level and water temperature data, and analyzing and determining a characteristic hydrological year of a study basin in combination with supplementary monitoring; establishing an unsteady one-dimensional hydrodynamic model for the entire study basin under the reservoir operation based on a reservoir operating mode, and simulating hydraulic characteristics of a downstream river course under the influence of reservoir operation in the characteristic hydrological year; wherein the hydraulic characteristics comprise flow rate, water level, and flow velocity, and the main habitat river section of the target fish species is then determined;
(1.2.2) establishing a two-dimensional hydrodynamic model for the main habitat river section of the target fish species, taking output results of the flow rate and water level from the unsteady one-dimensional hydrodynamic model as boundary conditions for the two-dimensional hydrodynamic model, coupling the unsteady one-dimensional hydrodynamic model to the two-dimensional hydrodynamic model to form a coupled hydrodynamic model, and simulating hydrodynamic changes in the main habitat river section of the target fish species; and
(1.2.3) establishing a one-dimensional water quality model for the entire study basin under the reservoir operation based on the reservoir operating mode, establishing a two-dimensional water quality model for the main habitat river section of the target fish species, taking output results of the dissolved oxygen and water temperature from the one-dimensional water quality model as boundary conditions for the two-dimensional water quality model, coupling the one-dimensional water quality model to the two-dimensional water quality model to form a coupled hydrodynamic model, and simulating concentration changes in water quality factors in the main habitat river section of the target fish species;
(1.3) investigating frequencies, distribution locations, area sizes, activities, and migration patterns of spawning ground, overwintering ground, and juvenile fish rearing ground of the target fish species, and recording flow rate, water temperature, water level, flow velocity, and dissolved oxygen value of each of the corresponding grounds as validation data for a fish habitat model;
(1.4) conducting behavioral experiments on the target fish species to establish a response relationship between behavior of the target fish species and flow rate, flow velocity, water temperature, and dissolved oxygen, obtaining a response curve between occurrence frequency of the target fish species and hydraulic characteristics, as well as a response curve between occurrence frequency of the target fish species and water quality factors;
(1.5) extracting flow rate and flow velocity results from the hydrodynamic changes in the main habitat river section of the target fish species, extracting water temperature and dissolved oxygen results from the water quality factor concentration changes in the main habitat river section, establishing a membership function between the occurrence frequency of the target fish species and hydraulic characteristics, and water quality characteristics based on a fuzzy membership in combination with the flow rate and flow velocity results, the water temperature and dissolved oxygen results, the response curve between occurrence frequency of the target fish species and hydraulic characteristics, and the response curve between occurrence frequency of the target fish species and water quality factors, and establishing a target fish species habitat model; and
(1.6) taking the flow rate and flow velocity in the hydraulic characteristics, as well as the water temperature and dissolved oxygen in the water quality factors as inputs, and the occurrence frequency of the target fish species as outputs; setting the occurrence frequency of the target fish species as an objective function for optimization using a genetic algorithm, setting population size, number of iterations, crossover probability, and mutation probability for the genetic algorithm, optimizing the membership function and fuzzy rules of the fish habitat model using the genetic algorithm, and validating whether the occurrence frequency of the target fish species in the target fish species habitat model is consistent with occurrence frequency of the target fish species in a field survey; when the occurrence frequency of the target fish species in the target fish species habitat model is inconsistent with that in the field survey, and an error between the model and the field survey is more than 10%, the population size, number of iterations, crossover probability, and mutation probability for the genetic algorithm are adjusted, and the target fish species habitat model is optimized again until the error between the model and the field survey is less than 10%, such that a target fish species habitat model corresponding to an optimal membership and fuzzy rules is obtained;
(1.7) taking suitability index and continuity index as evaluation indicators to establish a dynamic response relationship among habitat flow rate−suitability index, and flow rate−continuity curve for the optimized target fish species habitat model; and
(1.8) taking a flow rate corresponding to an optimal suitability index and connectivity index to calculate the ecological flow process throughout the life history of the target fish species based on the dynamic response relationship among habitat flow rate−suitability index, and flow rate−continuity curve, and dividing the ecological flow process into a minimum ecological flow process and a suitable ecological flow process; wherein an ecological flow process corresponding to a habitat restoration target of 60% is taken as the minimum ecological flow process, indicating that 60% of a target fish species habitat throughout the life history is recovered, and an ecological flow process corresponding to a habitat restoration target of 100% is taken as the suitable ecological flow process, indicating that 100% of the target fish species habitat throughout the life history is restored;
(2) calculating a critical spawning water temperature threshold and a critical gonadal development accumulated temperature threshold of the target fish species based on historical river water temperature data before dam construction, and calculating a critical spawning water temperature threshold and a critical gonadal development accumulated temperature threshold of the target fish species under an influence of current reservoir operation regulations based on river water temperature data after the dam construction; wherein
the step (2) specifically comprises the following sub-steps:
(2.1) calculating an average daily river water temperature over many years based on the historical river water temperature data before dam construction; and calculating an average daily river water temperature downstream of the dam based on the current river water temperature data according to the current operation regulation;
(2.2) calculating critical water temperature threshold and accumulated temperature threshold of the target fish species based on a historical daily river water temperature average; and
(2.3) calculating critical water temperature threshold and accumulated temperature threshold of the target fish species under the influence of current reservoir operation regulations based on an average daily water temperature downstream according to the current operation regulation; in the steps (2.2), (2.3) and (5.1), a river water temperature at which the average daily river water temperature reaches a level stably for the first time is selected as the critical water temperature threshold, and the level can trigger spawning behavior of the target fish species; and
“reach stably for the first time” means that the water temperature has been continuously higher than the water temperature value for the next 3 consecutive days; and in the steps (2.2), (2.3) and (5.1), the accumulated temperature is calculated and obtained by summing parts with temperature higher than a biological individual development temperature T₀ from a developmental stage to a mature stage (in days); in the process of calculating the accumulated temperature, assuming a plurality of the biological individual development temperatures as T₀ to minimize a difference among the accumulated temperatures in each survey year; and a variation range of the individual developmental temperature
$${T}_{0}^{fish}$$
of the target fish species is often determined based on a temperature at the beginning of the developmental stage of the target fish species, usually assumed to be in a range of 0-15° C.;
a calculation formula for the accumulated temperature threshold K of the target fish species is expressed as:
K=min (K_{mf}), K_{mf} is the K_{mα} obtained when
$${T}_{0 m} = {T}_{0}^{fish}$$
in a statistical year (1)
$${T}_{0}^{fish} = {T}_{0 f} ,$$
T_{0f} is an assumed T_{mα} when SDₘ is a minimum value
$$S {D}_{f} = min ( {SD}_{1} , {SD}_{2} … {SD}_{m} ) \qquad ( 2 )$$
$$S {D}_{m} = \sqrt{\frac{{\sum }_{α = 1}^{L} {( {K}_{m α} - \overline{K} )}^{2}}{L}} \qquad ( 3 )$$
$$\overline{{K}_{m}} = ( \frac{{\sum }_{α = 1}^{L} {K}_{m α}}{L} ) \qquad ( 4 )$$
$${K}_{m α} = {\sum }_{n = 1}^{n} {T}_{m α} , α = 1 … . . L \qquad ( 5 )$$
$${T}_{m α} = \{ \begin{matrix}{T}_{d α} - {T}_{0 m} & if {T}_{d α} > {T}_{0 m} \\ 0 & else {T}_{d α} \leq {T}_{0 m}\end{matrix} \qquad ( 6 )$$
in the formulae, K is the accumulated temperature threshold of the target fish species, in ° C.·d;
$${T}_{0}^{fish}$$
is the individual developmental temperature of the target fish species, in ° C.; T₀ₘ is an assumed individual developmental temperature, in ° C.; m is a number of assumed biological zero points; ƒ is an assumed T₀ₘ that achieves a minimum standard deviation; T_{mα} is a daily water temperature that contributes to fish development, in ° C.; α is a number of statistical years; SDₘ is a standard deviation of the accumulated temperature across all survey years, in ° C.·d; K̅ₘ̅ is an average accumulated temperature across all survey years, in ° C.·d; L is a number of years; K_{mα} is an accumulated temperature value in years, in ° C.·d; n is development time of species, in d; and T_{dα} is a river water level, in ° C.;
(3) establishing a multi-objective reservoir operation model orienting to needs of the ecological flow process throughout a life history of the target fish species to obtain flow process and water level after the optimized reservoir operation; wherein
the step (3) specifically comprises the following sub-steps:
(3.1) taking maximum power generation, highest satisfaction rate of ecological flow of the target fish species, highest water supply satisfaction rate, and longest suitable navigation period as objective functions of the multi-objective reservoir operation model;
a) the maximum power generation
$${f}_{1} = max {\sum }_{t = 1}^{T} {\sum }_{i = 1}^{2} {N}_{i . , t} Δ t \qquad ( 7 )$$
$${N}_{i , t} = {K}_{i} \cdot {Q}_{i , t}^{g} \cdot Δ {H}_{i , t} \qquad ( 8 )$$
in the formulae, f₁ is an objective function for power generation; T is a total calculation period length; N_{i,t} is a power output of an i^{th} reservoir of t time steps, in kW; Δt is a unit calculation time step; Kᵢ is a hydraulic power generation coefficient of the i^{th} reservoir;
$${Q}_{i , t}^{g}$$
is a power generation flow of an i^{th} hydropower station at a time period t, in m³/s; and ΔH_{i,t} is an average water level head of the i^{th} reservoir of the t time steps, in m;
b) the highest satisfaction rate of ecological flow when an outflow from the reservoir is lower than the minimum ecological flow process as stated in the step (1) throughout the life history of the target fish species, the satisfaction rate of ecological flow is 0; when the outflow from the reservoir falls within the minimum ecological flow process and the suitable ecological flow process as stated in the step (1) throughout the life history of the target fish species, the satisfaction rate of ecological flow increases with an increase in the flow rate; and when the outflow from the reservoir is greater than the suitable ecological flow process as stated in the step (1) throughout the life history of the target fish species, the satisfaction rate of ecological flow is 1;
an objective function for the satisfaction rate of ecological flow of the target fish species is as follows:
$${f}_{2} = max \frac{1}{T} {\sum }_{t = 1}^{T} {\sum }_{i = 1}^{2} {R}_{i , t} \qquad ( 9 )$$
$${R}_{i , t} = \{ \begin{matrix}0 & {Q}_{i , t}^{out} < {Q}_{t , min} \\ \frac{{Q}_{i , t}^{out} - {Q}_{t , min}}{{Q}_{t , pro} - {Q}_{t , min}} & {Q}_{t , min} < {Q}_{i , t}^{out} < {Q}_{t , pro} \\ 1 & {Q}_{t , pro} < {Q}_{i , t}^{out}\end{matrix} \qquad ( 10 )$$
in the formulae, f₂ is an objective function for the satisfaction rate of ecological flow of the target fish species; Q_{t,min} and Q_{t,pro} are minimum ecological flow need and suitable ecological flow need of the target fish species at a t^{th} time period, respectively, in m³/s;
$${Q}_{i , t}^{out}$$
is an outflow of the i^{th} reservoir of the t time steps, in m³/s; and T is a total calculation period length;
c) the highest water supply satisfaction rate
$${f}_{3} = max \frac{1}{T} {\sum }_{i = 1}^{T} \frac{{Q}_{sw , t}}{{Q}_{sw , t}^{demad}} \qquad ( 11 )$$
in the formula, f₃ is an objective function for the water supply satisfaction rate;
$${Q}_{sw , t}^{demand}$$
is a total water demand of t time steps, in m³/s, which is extracted from a water resources bulletin; Q_{sw,t} is a water supply flow of the t time steps, in m³/s; and T is a total calculation period length;
d) the longest suitable navigation period
$${f}_{4} = max \{ \frac{{T}_{n a v}}{T} \times 100 \% \} \qquad ( 12 )$$
$${T}_{n a v} = \{ t \vert {q}_{i , min}^{n a v} \leq {Q}_{i , t}^{o u t} \leq {q}_{i , max}^{n a v} , t ∈ T \} \qquad ( 13 )$$
in the formulae, f₄ is an objective function for navigation; T is a total calculation period length; Tₙₐᵥ is a suitable navigation period;
$${q}_{i , min}^{nav} and {q}_{i , max}^{nav}$$
are upper and lower bounds of a suitable navigation flow range downstream of the i^{th} reservoir, in m³/s; and
$${Q}_{i , t}^{out}$$
is an outflow of the i^{th} reservoir of the t time steps, in m³/s;
(3.2) determining constraint conditions of the multi-objective reservoir operation model, wherein the constraint conditions comprise reservoir water level constraint, reservoir capacity constraint, power output constraint, outflow constraint, and variable non-negative constraint;
a) the reservoir water level constraint
$${H}_{i , t}^{min} \leq {H}_{i , t} \leq {H}_{i , t}^{max} \qquad ( 14 )$$
in the formula,
$${H}_{i , t}^{min}$$
is a minimum water level of the p^{h} reservoir, equal to a dead storage level, in m; H_{i,t} is a water level of the i^{th} reservoir of the t time steps, in m;
$${H}_{i , t}^{max}$$
is a maximum water level of the i^{th} reservoir of the t time steps, which is a flood limit water level during a flood season and a normal storage level during a non-flood season, in m;
b) the reservoir capacity constraint
$${V}_{i , t + 1} - {V}_{i , t} = ( {Q}_{i , t}^{i n} + {q}_{t} - {Q}_{i , t}^{o u t} ) Δ t \qquad ( 15 )$$
$${Q}_{i , t}^{o u t} = {Q}_{i , t}^{g} + {Q}_{i , t}^{s p i} \qquad ( 16 )$$
in the formulae, V_{i,t+1} is a reservoir capacity of the i^{th} reservoir of t+1 time steps, in m³; V_{i,t} is a reservoir capacity of the i^{th} reservoir of the t time steps, in m³;
$${Q}_{i , t}^{in}$$
is an inflow into the i^{th} reservoir, in m³/s; qₜ is an inter-reservoir flow between cascade reservoirs, in m³/s;
$${Q}_{i , t}^{out}$$
is an outflow of the i^{th} reservoir of the t time steps, in m³/s;
$${Q}_{i , t}^{g}$$
is a hydropower diversion flow of the i^{th} reservoir, in m³/s; and
$${Q}_{i , t}^{spi}$$
is spilled water of the i^{th} reservoir, in m³/s;
c) power output constraint
$${N}_{i}^{min} \leq {N}_{i , t} \leq {N}_{i}^{max} \qquad ( 17 )$$
in the formula,
$${N}_{i}^{min} and {N}_{i}^{max}$$
are minimum and maximum power outputs of the i^{th} reservoir, respectively, in kW; and N_{i,t} is a power output of the i^{th} reservoir of the t time steps, in kW;
d) the outflow constraint
$${Q}_{i}^{min} \leq {Q}_{i , t}^{o u t} \leq {Q}_{i}^{max} \qquad ( 18 )$$
in the formula,
$${Q}_{i}^{min} and {Q}_{i}^{max}$$
minimum and maximum allowable outflows from the i^{th} reservoir, respectively, in m³/s; and
$${Q}_{i , t}^{out}$$
is an outflow from the i^{th} reservoir of the t time steps, in m³/s;
e) the variable non-negative constraint
$${V}_{i , t} , {N}_{i , t} , {Q}_{i , t}^{o u t} \geq 0 \qquad ( 19 )$$
in the formula, V_{i,t} is a reservoir capacity of the i^{th} reservoir of the t time steps, in m³; N_{i,t} is a power output of the i^{th} reservoir of the t time steps, in kW; and
$${Q}_{i , t}^{out}$$
is an outflow from the i^{th} reservoir of the t time steps, in m³/s; and
(3.3) optimizing and solving the multi-objective reservoir operation model orienting to needs of the ecological flow process based on a third-generation non-dominated genetic algorithm (NSGA-III); and iteration stops when an objective function value does not update any longer with an increase in the number of iterations, such that an optimized flow process and water level for the reservoir are obtained;
(4) coupling a water temperature model based on the multi-objective reservoir operation model orienting to needs of the ecological flow process to establish a multi-objective reservoir ecological operation model integrating both the ecological flow process and the water temperature process, and calculating reservoir outflow water temperatures before and after the optimized reservoir operation; wherein
the step (4) specifically comprises the following sub-steps:
(4.1) collecting vertical water temperature measurement data upstream of the reservoir and time series water temperature measurement data downstream of the reservoir;
(4.2) establishing the water temperature model, setting initial values for longitudinal eddy viscosity, longitudinal eddy diffusion rate, Manning's coefficient and wind shelter coefficient, surface solar radiation absorption coefficient, and pure water extinction coefficient of the water temperature model, and inputting reservoir inflow, outflow, water level, and meteorological data corresponding to the measured water temperature data at a same time into the water temperature model; wherein the meteorological data comprise air temperature, wind speed, wind direction, dew point temperature, and shortwave radiation;
(4.3) setting an outlet of the water temperature model to 2 outlet elevations of the current operation regulation, and calculating a reservoir outflow water temperature;
(4.4) comparing the calculated reservoir outflow water temperature with measured water temperature data; when an error between the calculated reservoir outflow water temperature and the measured outflow water temperature is great than 10%, the initial values for longitudinal eddy viscosity, longitudinal eddy diffusion rate, Manning's coefficient and wind shelter coefficient, surface solar radiation absorption coefficient, and pure water extinction coefficient of the water temperature model are adjusted until a calculated error between the calculated reservoir outflow water temperature and the measured outflow water temperature is less than 10%, so as to obtain calibrated and verified longitudinal eddy viscosity, longitudinal eddy diffusion rate, Manning's coefficient and wind shelter coefficient, surface solar radiation absorption coefficient, and pure water extinction coefficient;
(4.5) inputting the calibrated and verified longitudinal eddy viscosity, longitudinal eddy diffusion rate, Manning's coefficient and wind shelter coefficient, surface solar radiation absorption coefficient, and pure water extinction coefficient, and the water level and the outflow from the reservoir (that is, the optimized flow process and water level for the reservoir) calculated from the optimized multi-objective reservoir operation model in the step (3.3), as well as the corresponding meteorological data (comprising air temperature, wind speed, wind direction, dew point temperature, and shortwave radiation) into the water temperature model, setting an outlet elevation of the current operation regulation, and calculating reservoir outflow water temperatures before and after the optimized reservoir operation;
(4.6) setting up 8 outlets in the outlet setup for the water temperature model, wherein the 8 outlets comprise 2 outlets based on the current operation regulation, 4 outlets with elevated outlet elevation, and 2 outlets with lowered outlet elevation; the 4 elevated outlets are set as candidate outlets from March to June; the 2 lowered outlets are set as candidate outlets from October to the following January; and the 2 outlets based on the current operation regulation are set as candidate outlets for the remaining months;
(4.7) in the outlet setup for the water temperature model, using a historical daily water temperature average before the dam construction as a target; for the candidate outlets, outlet elevations for the 4 candidate outlets from March to June are optimized using the genetic algorithm, and for the 2 candidate outlets from October to the following January are optimized using the genetic algorithm, to obtain optimized outlet elevations from March to June, and from October to the following January, and outlet elevations for the remaining months are set according to the current operation regulation; and
(4.8) inputting the water level and the outflow from the reservoir (that is, the optimized flow process and water level for the reservoir) for the reservoir calculated from the optimized multi-objective reservoir operation model orienting to needs of the ecological flow process in the step (3.3), as well as the corresponding meteorological data (comprising air temperature, wind speed, wind direction, dew point temperature, and shortwave radiation) into the water temperature model, and setting as the optimized outlet elevations to calculate a reservoir outflow water temperature after the optimized reservoir operation; wherein
a governing equation for the water temperature model in the step (4) is as follows:
$$\frac{\partial U B}{\partial t} + \frac{\partial U U B}{\partial x} + \frac{\partial W U B}{\partial z} = gB sin α + g cos α B \frac{\partial η}{\partial x} - \frac{g cos α B}{ρ} {\int }_{η}^{z} \frac{\partial ρ}{\partial x} dz + \frac{1}{ρ} \frac{\partial B {τ}_{xx}}{\partial x} + \frac{1}{ρ} \frac{\partial B {τ}_{xz}}{\partial z} + q B {U}_{x} \qquad ( 20 )$$
$$0 = g cos α - \frac{1}{ρ} \frac{\partial P}{\partial z} \qquad ( 21 )$$
$${B}_{η} \frac{\partial η}{\partial } = \frac{\partial }{\partial x} {\int }_{η}^{h} U B d z - {\int }_{η}^{h} q Bdz \qquad ( 22 )$$
$$\frac{\partial U B}{\partial x} + \frac{\partial W B}{\partial z} = qB \qquad ( 23 )$$
$$ρ = f ( {T}_{w} , {ϕ}_{TDS} , {ϕ}_{ss} ) \qquad ( 24 )$$
$$\frac{\partial B ϕ}{\partial t} + \frac{\partial U B ϕ}{\partial x} + \frac{\partial W B ϕ}{\partial z} - \frac{\partial ( B {D}_{x} \frac{\partial ϕ}{\partial x} )}{\partial x} - \frac{\partial ( B {D}_{z} \frac{\partial ϕ}{\partial z} )}{\partial z} = {q}_{ϕ} B + {S}_{ϕ} B \qquad ( 25 )$$
in the formulae, U is a horizontal flow velocity, B is a river course width, g is an acceleration of gravity, ∂x, ∂y and ∂z denote partial derivatives with respect to x, y, and z directions, respectively, W is a vertical flow velocity, α is a river course angle, η is a water surface elevation, ρ is a density, q is a flow rate per unit width, P is a pressure, ϕ is concentration or temperature, T_{w} is a water temperature, ϕ_{TDS} is total dissolved solid concentration or salinity, ϕₛₛ is an inorganic suspended solid concentration, and h is a depth;
(5) calculating an improvement difference between the critical water temperature threshold and the accumulated temperature threshold of the target fish species on arrival dates after reservoir ecological operation and those before the optimized reservoir operation, as well as a difference between the critical water temperature threshold and the accumulated temperature threshold of the target fish species after the reservoir ecological operation and those in an ideal state of the river before the dam construction; wherein
the step (5) specifically comprises the following sub-steps:
(5.1) identifying the reservoir outflow water temperature after the optimized reservoir operation as daily average river water temperature after the reservoir ecological operation, and calculating critical water temperature threshold and accumulated temperature threshold of the target fish species after the reservoir ecological operation;
(5.2) subtracting an arrival date of the critical water temperature threshold under the current operation regulation (that is, conventional operation) from an arrival date of the critical water temperature threshold of the target fish species after the reservoir ecological operation to obtain an improvement difference of the critical water temperature threshold of the target fish species after the reservoir ecological operation; and subtracting the critical water temperature threshold of the target fish species before the dam construction from the critical water temperature threshold of the target fish species after the reservoir ecological operation to obtain a difference between the critical water temperature threshold of the target fish species after the reservoir ecological operation and that in an ideal state of the river before the dam construction; and
(5.3) subtracting the accumulated temperature threshold of the target fish species under the current operation regulation (that is, conventional operation) from the accumulated temperature threshold of the target fish species after the reservoir ecological operation to obtain an improvement difference of the accumulated temperature threshold of the target fish species after the reservoir ecological operation; and subtracting the accumulated temperature threshold of the target fish species before the dam construction from the accumulated temperature threshold of the target fish species after the reservoir ecological operation to obtain a difference between the accumulated temperature threshold of the target fish species after the reservoir ecological operation and that in an ideal state of the river before the dam construction.
